(19) United States
(12) Patent Application Publication
(10) Pub. No.: US 2022/0010763 A1
(43) Pub. Date: Jan. 13, 2022

(54) FFWN CLEAN ENERGY POWER PLANT

(71) Applicant: Edward Von Bargen, Shirley, NY (US)

(72) Inventor: Edward Von Bargen, Shirley, NY (US)

(21) Appl. No.: 17/363,753

(22) Filed: Jun. 30, 2021

Related U.S. Application Data
(60) Provisional application No. 63/048,880, filed on Jul. 7, 2020.

(51) Int. Cl. F03B 13/10; H02K 7/18

(52) U.S. Cl. CPC F03B 13/10; F05B 2220/706; F05B 2220/32; H02K 7/1823

(57) ABSTRACT

Gravity and hydrostatic pressure are natural forces that have considerable force generating capabilities which can make significant contributions during the operation of a FFWN 24/7/365, baseload, 100% clean energy power plant. When these natural forces are combined with compressed air in the upper part of an elevated storage tank containing a liquid and the partial vacuum created by powerful pumps to produce a targeted water flow rate velocity of about 31.3 m/s through the entire length of a coiled section of pipe containing one or more helical turbines in each coil that are connected to an external generator, the electricity produced during a power producing cycle by all the turbines/generators when combined will be considerably more than the power ultimately consumed by the pumps to return the highly pressurized water in a ground level tank back to the storage tank utilizing a return tank and simple water displacement.

### CROSS REFERENCE TO RELATED APPLICATION

This patent application is related to and claims the benefit of provisional application Ser. No. 63/048,880, filed on Jul. 7, 2020, which is incorporated herein by reference.

### BACKGROUND

The present invention relates to FFWN (Fossil Fuel's Worst Nightmare) clean energy power plants, and more particularly, to 24/7/365, baseload, one-hundred percent clean energy power plants.

Hydro-electric power plants and nuclear power plants are two current types of baseload electric power plants that do not require the burning of fossil fuels. Historically, there have been many attempts by inventors to invent other types of clean energy power plants that could be used to replace natural gas and coal-fired power plants as baseload electric power sources. Up until now, one of the few with the ability to produce a fairly significant amount of surplus electric power has been an ocean thermal energy conversion (OTEC) power plant.

An OTEC power plant converts solar energy to electrical energy by using the naturally occurring temperature difference between warm surface water found in locations near the equator and the cold water that is pumped up through large pipes from thousands of feet below the surface to complete a power producing cycle. As long as the temperature difference between the warm surface water and the cold deep water is about 20 degrees Celsius, an OTEC power plant can produce a fairly significant amount of surplus electric power. Unfortunately, due to the high cost of building and maintaining an OTEC power plant, as well as the low overall efficiency of an OTEC power plant of 2% to 3%—which typically uses nearly as much electricity as it produces to run the pumps and convert back to liquid form the vaporized low boiling point fluid that is used to drive a turbine/generator and ultimately produce net electric energy—it has not been a commercial success.

Intermittent power from wind turbines and solar panels can be combined with batteries and other forms of energy storage to provide a baseload power source. However, because solar is only good for about 4 hours of power on average daily globally, and wind for less than 6 hours of power on average daily globally, doing so would be very expensive. As a result, wind, solar, batteries and other forms of energy storage are usually further combined with backup power from natural gas power plants to supply a reliable source of electric power.

One of the most efficient and widely used types of bulk (large-scale) energy storage is pumped-hydro energy storage (PHES). PHES stores energy in the form of the gravitational potential energy of water that has been pumped from a lower elevation to a higher elevation through a long pipe and stored in a large receptacle of water which can be either natural or man-made. At times of low electricity demand, low-cost off-peak electric power is used to run the pump. At times of higher electricity demand, water is released back into the lower source of water after first passing through a turbine and generating electricity. In most cases, a reversible turbine/generator acts as both the pump and the turbine/generator.

A water tower of a typical municipal water provider is in essence being used as a PHES upper receptacle by simply refilling the water tower at night or during other times when low-cost electricity is available to run the refilling pump. From there, the hydrostatic pressure caused by the elevated stored water is then used to deliver pressurized water to homes and businesses without any further significant use of electric power.

Hydrostatic pressure caused by an elevated liquid source can also be used in other useful ways. One such way, as disclosed in U.S. Pat. No. 5,916,441 to Raether for “Apparatus for desalinating salt water,” uses gravity to provide hydrostatic pressure as operational pressure to force desalinated product water through a reverse osmosis membrane that is located at the bottom of a vertical mine shaft that is at least 550 meters (or about 1,800 feet) deep and can produce at least 800 psi of pressure. The same hydrostatic pressure, which includes the initial pressure provided by atmospheric air pressure, is then further used to move the brine water left over from the desalination process into another vertical mine shaft, where it rises most of the way back to the surface (just like water in a U-shaped tube seeking the same level in both legs). However, the brine water does not reach the surface because it has greater density than the original salt water. A pump is therefore needed to lift the greater density brine water the remaining distance to the top of the mine shaft so it can be returned to the source of the salt water. And while this disclosure does state that the electrical pumping costs related to the largest amount of water to go through the system is minimal compared to conventional reverse osmosis desalination systems—with more than half and as much as two-thirds of the electrical operating costs saved compared to conventional systems—Raether's invention is an apparatus for desalinating salt water and not an electric power plant. There will also be no difference in the density of the liquid used to produce electricity. As a result, if an embodiment of the present invention requires that the liquid be returned to its elevated source after it reaches the bottom of the unit, the liquid will have the potential to seek the same level of the liquid at the surface of its source due to the naturally occurring forces of atmospheric air pressure and hydrostatic pressure, and have the potential to do so, regardless of the overall height or vertical length of the unit of the invention.

Another desalination apparatus, as disclosed in U.S. Pat. No. 5,366,635 to Watkins for “Desalination system and process,” uses the hydrostatic pressure in a body of sea water that has a depth of at least 461 meters (or about 1,500 feet) to force sea water through reverse osmosis membranes to perform the desalination process. Because a pressure differential must exist between the separator means inlet in communication with the body of sea water and the separator means outlet for the apparatus to operate, a pump is used to create a partial vacuum within the tank chamber as it simultaneously pumps the incoming desalinated product water out of the tank chamber and up to an onshore facility.

U.S. Pat. No. 4,055,950 to Grossman for “Energy conversion system using windmill,” discloses a system that uses wind power to produce compressed air, which is stored in tanks. The compressed air is then used to increase the pressure of a liquid contained within another tank, with the pressurized liquid then used to activate and operate a work-producing apparatus, such as a generator, in a controlled manner until the liquid is driven from the tank by the compressed air.

U.S. Pat. No. 4,206,608 to Bell for “Natural energy conversion, storage and electricity generation system,” discloses a system that uses at least one source of natural energy, such as wind, solar, wave or tide, to pressurize a liquid, with the pressurized liquid stored in high pressure storage tanks, The pressurized liquid is then supplied when needed to another high pressure tank containing a compressible fluid, such as air or nitrogen, with the compressible fluid, which may include air that is already compressed to 1000 psi, compressed by the supplied pressurized liquid, which may be pressurized to a pressure between 2,000 and 4,000 psi, until the tank is nearly full of liquid. The highly pressurized liquid and compressible fluid can then be used as needed to produce electric power, with the compressible fluid expanding to drive the liquid out of the tank through a conduit to a hydro-electric generating device which uses pressurized liquid to generate electricity in a controlled manner.

U.S. Pat. No. 6,672,054 to Merswolke et al for “Wind powered hydroelectric power plant and method of operation thereof,” discloses a system that uses wind power to produce compressed air, which is stored in storage tanks and high pressure air reserve tanks, with the compressed air then used to increase the pressure of the water contained in other storage tanks that are nearly filled with water. The compressed air in a water storage tank is then used when needed to force the water out of the water storage tank through a water outlet at the bottom of the tank and into a collector line that is connected to a collection of water storage tanks and also connected to the water inlet of a water turbine, which is used to generate electricity in a controlled manner using the high pressure water from one water storage tank at a time until the water is driven from the water storage tank being emptied.

U.S. Pat. No. 9,546,642 to Deng for “Energy-storing and power generating system and method for a vertical-axis wind generator,” discloses a system that uses wind power from a vertical-axis wind turbine to produce compressed air, which is stored in a high pressure tank. The compressed air is then used to increase the pressure of the water in a water tank, with the compressed air in the water tank then used when needed to force the water out of the water tank through a water outlet pipe below the water tank that is in communication with a water turbine close to the ground to generate electricity in a controlled manner until the water is driven from the water tank.

The four above mentioned patents that use compressed air to increase the pressure of a liquid within a tank use intermittent or unreliable power sources to produce compressed air that is stored in storage tanks. The above mentioned patents that use compressed air to increase the pressure of a liquid within a tank also use the stored compressed air to increase the pressure of the liquid within a tank so the pressurized liquid can be used to generate electric power in a controlled manner until the water is driven from the tank by the compressed air. Also, none of the above mentioned patents that use compressed air to increase the pressure of a liquid within a tank produce more electric power than they consume. This is largely due to the highly inefficient process of producing the compressed air, how the pressure of the compressed air decreases as it drives the water out of the tank (for instance, if the area occupied by the compressed air is doubled as it drives the water out of the tank the pressure of the compressed air will be cut in half), how the tanks containing pressurized water for the purpose of producing electric power repeatedly need to be refilled, and how the pressurized water is used to produce a limited amount of electric power by driving a single energy producing device.

### SUMMARY OF THE INVENTION

In view of the inherent limitations of the prior art, embodiments of the present invention that use compressed gas—preferably compressed air—to dramatically increase the pressure of the liquid used throughout the system will have several advantages: (1) Except for minor losses, which may require the periodic addition of additional liquid, the level of the liquid within the system will largely be unchanged. (2) The compressed air will essentially be trapped within an airtight and watertight storage tank while the power plant is in operation so it can constantly be used to apply pressure to the liquid in the storage tank. (3) After the initial setup of the power plant, any compressed air that may be added periodically will preferably be produced with surplus power that might have otherwise gone to waste. (4) The overwhelming pressure provided by the compressed air constantly pushing on the liquid in the storage tank, which will make it possible for powerful pumps to dramatically increase the flow rate velocity of the liquid flowing through multiple turbines within a coiled section of pipe, will dramatically increase the efficiency and power output of the power plant. (5) The dramatic increase in the efficiency and power output of the power plant will make it possible to produce large quantities of surplus electric power.

It is therefore an object of the present invention to produce one-hundred percent clean electric power 24 hours a day, 7 days a week, 365 days a year.

It is also an object of the present invention to be a reliable baseload power source and power plant.

It is also an object of the invention to use an elevated storage tank or other containment vessel, the volume of water or other liquid within it capable of creating hydrostatic pressure and facilitating the beneficial effects of naturally occurring forces, such as gravity and atmospheric air pressure, to rotate turbines that drive generators as the water or other liquid flows down through a series of pipes or other conduits coupled to the elevated storage tank or other containment vessel.

It is also an object to use a coiled section of pipe to increase the length of the series of pipes or other conduits that are coupled to the elevated storage tank or other containment vessel in order to increase the number of turbines and generators that can simultaneously generate electricity, as well as limit the vertical distance the water or other liquid must be returned to the elevated storage tank or other containment vessel after it reaches the bottom of a unit.

It is also an object to have hydrostatic pressure and atmospheric air pressure, which are made possible or their beneficial effects facilitated by the elevated water or other liquid that is used to rotate turbines and generate electricity, be capable of pushing the water or other liquid back up through one or more return pipes or other conduit to a level that is in equilibrium with the level of the water or other liquid in the elevated storage tank or other containment vessel so it will take less electric power to return the water or other liquid the remaining distance back into the elevated storage tank or other containment vessel using a pump or pumps.

It is also an object to have the electric power produced by the turbines/generators exceed the amount of electric power needed to run the pump or pumps that are used to return the water or other liquid back into the elevated storage tank or other containment vessel, thus producing a steady supply of surplus or net positive electric power.

It is also an object to have the pumps that are used to return pressurized water or other liquid to the elevated storage tank or other containment vessel be able to increase and control the rate the water or other liquid moves throughout the system, thereby increasing and controlling the amount of electric power that can be produced by the power plant.

It is also an object to use the partial vacuum or lower pressure zone created by the pumps and the pressure applied to the surface of the water or other liquid in the elevated storage tank to increase the flow rate velocity of the water or other liquid through the turbines in the coiled section of pipe so the kinetic energy of the water or other liquid will be increased and the amount of energized water or other liquid interacting with the turbines per minute will be increased, thereby increasing the amount of electric power produced by the power plant.

It is also an object to have more pumps or pumping capacity than needed for the power plant to operate at its normal operating capacity or nameplate capacity (which will, in larger capacity embodiments of the invention, preferably be about 33% less than the targeted or top capacity of the power plant), as well as have sister pumps or backup pumps included in the system, which may be used to rest a pump periodically or to perform maintenance on a pump without interrupting electricity production.

It is also an object to use compressed air to increase the pressure being applied to the surface of the water or other liquid within the upper part of an airtight and watertight elevated storage tank or other containment vessel beyond atmospheric air pressure to maximize the flow rate velocity of the steady flow of energized water or other liquid flowing down through the turbines in the coiled section of pipe before entering into the ground level tank or other high volume ground level fluid receptacle and finally into the partial vacuum or lower pressure zone created at the eye of the impeller of one or more centrifugal pumps when centrifugal pumps are used to increase and control the rate the water or other liquid moves throughout the system.

It is also an object to use gravity, momentum, the increased pressure from compressed air in the upper part of the elevated storage tank, and hydrostatic pressure to provide a steady flow of water or other liquid into the partial vacuum or lower pressure zone at the eye of the impeller of the centrifugal pumps, which will be further assisted by the increased hydrostatic pressure of the water or other liquid in the ground level tank or other high volume ground level fluid receptacle, so the pumps can maximize the flow rate velocity of the water or other liquid through the energy generating parts of the system and simultaneously return the pressurized water or other liquid from the bottom of the unit back into the elevated storage tank or other containment vessel.

It is also an object to use a return tank or similar conduit and water displacement to more efficiently return the pressurized water or other liquid, which will preferably be pumped horizontally into the return tank or similar conduit from an airtight and watertight ground level tank or other ground level fluid receptacle that is in communication with the elevated storage tank or other containment vessel through one or more sections of pipe or other conduit, back to the elevated storage tank or other containment vessel when the return tank or similar conduit is appropriate to use.

It is also an object to use an Al-enabled control system so the power plant can produce the requested or desired amount of electricity within the top capacity of the power plant as accurately and efficiently as possible while the power plant is in operation, as well as use an Al-enabled control system so the power plant can communicate securely with other smart infrastructure.

To achieve these and other objectives, the present invention is a method and system for the scientifically sound, environmentally friendly, and economically unmatched production of 24/7, baseload, one-hundred percent clean electric power.

The present invention comprises an electrical generation system that generates electrical energy by utilizing the flow of water or other liquid through a pipe or other conduit to rotate turbines within the pipe or other conduit with the turbines preferably connected to external generators that generate electricity. The electrical generation system further utilizes the force of gravity to the extent possible to increase the flow rate velocity and kinetic energy of the water or other liquid, as well as air pressure and water or hydrostatic pressure to the extent possible to efficiently move the liquid throughout the system and return it back to its source using one or more pumps.

Numerous embodiments of the present invention are possible. They include configurations (or embodiments) in which the source of the water or other liquid is located on land and stored in a well-constructed containment vessel, preferably a tank. In such instances, the storage tank may be raised or elevated at different heights above ground level in order to maximize the amount of hydrostatic pressure and electric power that can be produced as well as meet other ambitious goals and still comply with requirements such as those related to local building codes. Other land-based configurations will have the elevated storage tank located near, at, or below ground level. But whether the elevated storage tank is located above ground level or located near, at, or below ground level, the pipes or other conduits that are used to contain and direct the flow of the pressurized water or other liquid once it leaves the storage tank will preferably be coupled to and start from the bottom of the storage tank.

The liquid within the storage tank—which will preferably be clean (potable) drinking water, although treated sewage water, drainage water, water with additives such as different alcohols or other types of anti-freeze, or possibly even salt water or other liquids with greater density than potable water—will preferably first exit through a release valve that is preferably located on the bottom of the storage tank.

Once through the tank release valve, the water will then enter a pipe (or multiple pipes in some of the larger capacity embodiments of the invention or those that are intended to operate 24/7/365) or other similar conduit that preferably starts out heading straight down at its origin for a relatively short distance that is preferably 20% of the height of the remainder of the unit below the storage tank. This relatively short section of down-pipe, which may start out wider at the top than at the bottom, will be used in part to make it possible for the water to accelerate downward at as fast a rate as possible due to the force of gravity, but will primarily be used to give the mechanically controlled movement of the water down through the system, which will be made possible by the system's pump or pumps (at least in the best performing embodiments of the invention), a little more time and space to impart their influence on the downward flow of water. In these best performing embodiments of the present invention that will preferably make use of mechanical means along with natural forces to rapidly move the water throughout the system, the pumps, which will also ultimately be used to return the water to the storage tank that is already capable of being pushed back up to the level of the water within the storage tank due to atmospheric pressure and hydrostatic pressure (envision a U-shaped piece of clear rubber hose with the water at both ends seeking the same level), will typically have their pumping efficiencies increased and the amount of electricity they consume reduced by taking advantage of the pressurized water within the watertight and airtight potential conduits at the bottom of the electricity generating portion of the system, which will extend from the surface of the water in the elevated storage tank to where the pump or pumps preferably connect directly to a ground level tank.

In embodiments of the invention that use pumps to increase the flow rate velocity of the water beyond what can be achieved by gravity alone, the speed of the flowing water, after initially passing through a tank release valve and also preferably flowing straight downward into a short section of down-pipe, will be controlled by the pumps. This is because the movement of the water by the pumps, which is made possible by the partial vacuum or lower pressure zone created by the pumps, will extend from the surface of the water within the storage tank, where atmospheric air pressure, or preferably higher pressure provided by compressed air or increased pressure produced through mechanical means, will constantly be pushing down with a considerable amount of pressure, to the pumps, with the flow rate velocity of the water calibrated in such a way that it will be under the control of the pumps and be able to be maintained at a targeted velocity by the time the water reaches the next section of pipe containing the turbines/generators and starts generating electricity.

In order to increase the number of turbines/generators that can be driven by the flowing water, many different configurations of pipes and pipe sections may be employed by the present invention. In the most preferred combination of pipe sections, after the flowing water reaches the bottom of the short section of down-pipe, it will then enter the next section of pipe (or other conduit) that will preferably be coiled like a spring and be similar in appearance to a child's coiled drinking straw. This coiling of the pipe, when compared to a pipe that extends straight down to the bottom of the unit, will make it possible to increase the overall length of the pipe by ten times or more in the preferably at least 80% of remaining vertical distance between the bottom of the down-pipe and where the end of the coiled section of pipe is preferably coupled to a ground level pipe or to the top of a ground level tank or other conduit.

This dramatic increase in the overall length of the pipe by ten times or more in the available space between the bottom of the down-pipe and the potential conduits at the bottom of the unit, whose primary purpose will be to return the pressurized water within it back to the storage tank, will be one of the main reasons and most important concepts behind why the present invention will work so well. And, of course, the increase in the overall length of the pipe by the ten times or more will be able to be accomplished with each coil having a relatively small diameter and circumference when compared to the inside diameter of the pipe. It will also occur regardless of the total distance between the bottom of the storage tank and the end of the coiled section of pipe, and that includes the fact that at least one turbine/generator will preferably be included in each coil of the coiled section of pipe and that the length of the coiled section of pipe will be able to be increased even more if the storage tank is elevated above ground level and the coiled section of pipe extends down below ground level.

In less powerful embodiments of the present invention that rely primarily on natural forces to produce surplus electric power, as with how the municipal water lines that branch out from a water tower can extend for miles and still provide pressurized water to homes and businesses, if a typical section of pipe is coupled to the end of the coiled section of pipe at or near the bottom of the unit it will contain pressurized water that can be used to do more than just increase how efficiently the water is returned to the storage tank due to how the water is already capable of being pushed up to the level of water within the storage tank by atmospheric pressure and hydrostatic pressure. That includes having the next (ground level) section of pipe run horizontally along various paths in order to extend the overall length of the main section of pipe and also the number of pipe sections that can be used to generate electricity, and can be done by placing additional turbines/generators in the ground level section of pipe, which will increase the total number of turbines/generators that can simultaneously produce electric power before the ground level pipe transitions into becoming a return pipe when it preferably loops back up toward the storage tank.

As previously mentioned, in more powerful embodiments of the present invention there will preferably be an airtight and watertight ground level tank or other large volume water receptacle coupled to the end of the coiled section of pipe that will preferably have multiple pumps coupled directly to it at the bottom of the unit. The pumps will preferably then use return pipes coupled to their discharge outlet to return the pressurized water back up and into the storage tank or, in instances when it makes sense, use other means that take advantage of a separate return tank and simple water displacement (more on them later) to more efficiently return the pressurized water up and into the storage tank. Also, depending on the inside diameter of the previous sections of pipe, the number of gallons of water that will be cycling through the system per minute, the number and size of the pumps that will be needed to provide a continuous and adequate flow rate velocity of water to produce the desired amount of electricity, as well as how the elevated storage tank will be supported or held aloft, a larger diameter and volume ground level pipe, in communication with or connected directly to one or more pumps, may also be used.

Due to the ability to use hydrostatic pressure, including the initial 14.7 pounds-per-square-inch (psi) of pressure provided by atmospheric pressure, to push the water within a return pipe back up to the height of the water within the storage tank, the overall length of the different sections of pipe employed by the system can be made very long without the height that the water can reach within the return pipe being affected. However, in order for an embodiment of the present invention that relies primarily on natural forces to become a 24/7, baseload, one-hundred percent clean energy power plant, in addition to it being necessary to determine the proper height to position the top of the return pipe (or pipes) so the invention can maintain a steady flow of water out of it and, as a result, also determine the rate at which the water will flow out of the return pipe, it will also be necessary to determine the size and number of pumps that will be needed to efficiently maintain a continuous flow of water throughout the system. Toward that end, if the top of a return pipe was placed next to the storage tank at the same height as the water within the storage tank, just by lowering the top of the return pipe below where the water height within the return pipe is in equilibrium with the height of the water within the storage tank, the water will start to flow freely out of the top of the pipe and the rate of water flow will continue to increase as the top of the return pipe is lowered. This continues to be true regardless of the inside diameter of the return pipe, how many coils are in the coiled section of pipe or what the diameter of the coils are, and the rate of water flow will begin to be quite robust even without the top of the return pipe lowered very far in relation to the overall height of the unit (envision the pipe of a fire hydrant that has been detached from the fire hydrant after an accident shooting water straight up into the air).

Additionally, as with how atmospheric pressure and hydrostatic pressure will make it possible for the overall length of the pipe in the coiled section of pipe to be very long when compared to the overall height of the unit and not affect the ability of the water to rise in a return pipe to the level of the water within the storage tank, something very similar will also hold true for the number of turbines/generators that can be placed within the coiled section of pipe. And while each turbine/generator does indeed convert the kinetic energy of the flowing water into electrical energy and have an effect on the flow of the water as it passes through each individual in-pipe turbine that will preferably be used with the invention (more on the turbines later), since there is no blockage or “backing up” of the water in any part of the pipe as a result of its interaction with the turbine/generator, and also in part because hydrophobic or other specialty coatings will preferably be applied to the interior walls of the pipes to reduce friction, after the flowing water interacts with the preferred in-pipe turbine, the water velocity will quickly return to the flow rate determined by the flow rate and amount of pressurized water exiting the system through the open end of the return pipe. This means that as long as there is an adequate amount of space between the turbines/generators, the number of turbine/generators that can reasonably be deployed in the main section of pipe can be deployed in an embodiment of the invention that relies primarily on the water flow rate velocity that hydrostatic pressure, including atmospheric pressure, can consistently produce out of the open end of the return pipe, which includes whether the open end of the return pipe is just meters below the storage tank or the water is allowed to reach the velocity possible at the bottom of the unit.

A prototype was built to test how the inclusion of a large number of in-pipe turbines within a coiled section of pipe would affect the rate of water flow and the height of the open end (or top) of a single return pipe when water was allowed to flow freely through the entire length of the different sections of pipe and out the open end of the return pipe while benefitting only from the natural forces of gravity, atmospheric air pressure and hydrostatic pressure. Even with a turbine located one-over-the-other within each coil of the coiled section of pipe and the top of the return pipe situated at many different heights, the pressurized water flowed freely out of the open end of the return pipe when there was nothing in the coiled section of pipe and when there were turbines in the coiled section of pipe. The test results also confirmed that guides or other water flow direction control devices could be used to accelerate and compress water flow right before the turbines to increase power production. And, of course, in all instances, the flow rate velocity of water out of the open end of the return pipe was slower the higher the top of the return pipe was situated in relation to the level of the water in the storage tank and faster the closer the open end of the return pipe was situated in relation to the bottom of the coiled section of pipe—a simple fact that will be important for several reasons in the best performing embodiments of the invention.

The amount of electricity that a single unit of the power plant can produce per hour (or its capacity) will also vary quite a bit. The different capacities that different embodiments of the FFWN Clean Energy Power Plant can be built will range from a relatively small number of watts per hour up to 200 megawatts or more per hour in some of the larger capacity embodiments of the present invention that are possible. The large number of gallons of water that will need to be returned into the storage tank per minute in order to produce the amount of electricity that some of the larger capacity units will be able to produce per hour will require the use of many pumps if the unit is going to be operated as efficiently and cost-effectively as possible. The number and size of the pumps, as well as the different ways the pumps will be able to be configured to return or be a component in a more complex system to return the pressurized water back into the storage tank, will also vary widely.

A relatively easy way to return the water to the storage tank using an embodiment of the present invention that includes a single ground level pipe and a single return pipe, will be to set up a support structure in the form of a platform that will preferably be located below the storage tank in the open space next to the down-pipe and be used to hold a water receptacle for the pressurized water from the bottom of the unit to flow freely up through a return pipe and into at a fairly fast rate. Once in the much smaller water receptacle than the main storage tank still higher above, any number of pumps with the ability to pump the water the relatively short distance into the storage tank, as well as keep up with the rate of water flowing freely into the lower water receptacle through the open end or top of the return pipe (or, just as importantly, also having a pumping capacity at least equal to the amount of water in gallons-per-minute interacting with each turbine in the coiled section of pipe per minute) will be able to do so. However, because it is an objective of the present invention to have the pumps that are used to return the water to the storage tank be able to increase and control the flow rate of water throughout the system and, thereby, also increase and control the amount of electricity produced by the unit, the just described embodiment of the invention—which relies primarily on the beneficial effects of the natural forces of gravity, atmospheric pressure and hydrostatic pressure, as well as having a sufficient number of coils and turbines/generators included in the coiled section of pipe to successfully complete a power producing cycle that produces surplus electric power—will not be the preferred one.

In a more preferred embodiment of the invention, albeit still one of the lower capacity embodiments possible, instead of using hydrostatic pressure to push the water up into an intermediary water receptacle to create a water flow and shorten the distance the water needs to be returned to the storage tank, the storage tank will no longer be vented and will instead be made airtight and watertight so the upper part of the storage tank can be filled with a compressed gas, preferably compressed air. Due to how the hydrostatic pressure of the water at the bottom of a unit will be 14.7 psi (pounds-per-square-inch) for every 10 meters or approximately 33 feet of water depth from the surface of the water in the storage tank to the lowest point in the system plus the pressure provided by the air pushing down on the surface of the water in the storage tank (atmospheric air pressure is 14.7 psi at sea level), by filling the upper part of the storage tank with compressed air above 14.7 psi the hydrostatic pressure of the water at the bottom of the unit will be increased commensurate with the increased pressure of the compressed air.

In addition to the potential to increase the hydrostatic pressure of the water at the bottom of the unit by introducing compressed air into the upper part of the storage tank because the hydrostatic pressure, which increases in proportion to the measured depth from the surface because of the increasing weight of the water exerting downward force from above plus any pressure acting on the surface of the water, at least one pump will also be coupled to the top of each return pipe that is incorporated into the system with an airtight and watertight connection. By being directly attached to the top of the return pipe, the pump will be able to increase the flow rate velocity of water up through the return pipe instead of it gradually slowing down, even with all the additional pressure provided by the compressed air in the upper part of the storage tank, as the operational pressure provided by hydrostatic pressure normally starts to diminish the higher it helps push the water up. This is because the pump is going to produce a considerable amount of additional water flow velocity—especially as part of what is now a closed system that includes the portion from the inlet or suction side of the pumps back down through the return pipes and then back up through the main section of pipe to the surface of the water in the storage tank—and be very effective at also increasing the flow rate velocity of the water through all the turbines in the coiled section of pipe, which will already have the potential to be dramatically increased by the compressed air in the upper part of the storage tank applying constant pressure to the surface of the water in the storage tank.

With an ample amount of compressed air trapped in the upper part of the storage tank, as well as the pumps that are incorporated into the system coupled to the tops of the return pipes, and the partial vacuum or lower pressure zone created by the pumps during their normal operation put to good use to increase and control the flow rate velocity of the water through the watertight and airtight system, another benefit of attaching the pumps to the return pipes will be how they will also increase the overall efficiency and capacity of the power plant. In fact, if done properly, by directly attaching the pumps to the return pipes—or even better yet, directly to a larger diameter and volume ground level section of pipe or ground level tank at the bottom of the unit (which will also make it possible to incorporate larger, more powerful and an increased number of pumps into the system)—using the pump or pumps to create a closed system has the potential to dramatically increase the capacity of the power plant well beyond what is possible using only natural forces. That includes placing as many turbines/generators in the coiled section of pipe as is operationally possible beyond the point where the downward flowing water has had a chance to achieve the targeted flow rate velocity controlled by the pump(s), with the turbines/generators possessing the ability to operate normally at much faster flow rate velocities than what gravity, hydrostatic pressure and atmospheric pressure can produce through the coiled section of pipe.

One a the most important ways the efficiency of the power plant will be increased by using the pumps to create a closed system has to do with how the system's pumps work and how the pressure of the water entering the pump can be utilized. This is because, after being reduced by a comparatively small amount by the impeller while producing the partial vacuum or lower pressure zone needed for the pump to operate, the pressure of the water entering each pump will be able to be subtracted from the outlet discharge pressure needed to return the water back up and into the storage tank at the desired flow rate. What this means is that whatever the water pressure is before it enters the pump will typically be about 14.7 psi (or atmospheric pressure at sea level and typically about what the water pressure is reduced to create the partial vacuum or lower pressure zone) more than what it is after it enters the pump and that the pump will only need to make up the difference between the water pressure entering the pump and the outlet discharge pressure needed to return the water into the storage tank at the desired flow rate regardless, in this instance because of how the system is configured, of what the pressure of the compressed air in the upper part of the storage tank is, What this also means is that as long as the pressure of the compressed air in the upper part of the storage tank is high enough to drive a constant stream of water through the main section of pipe and up into the pump(s) to meet whatever flow rate velocity is being targeted by the Al-enabled control system, the pump(s) will be able to be positioned at any location along the vertical length of the return pipe(s) with little difference in its efficiency, meaning the amount of electricity used to run the pump will not vary very much.

This will also hold true if the pumps that are incorporated into the system are in communication with or connected to the ground level pipe. This is because regardless of where the pump is connected to the conduit or conduits that are used to return the water to the storage tank, the pump will only need to make up the difference between the water pressure entering the pump and the outlet discharge pressure needed to return the water into the storage tank at the desired flow rate. And because the hydrostatic pressure, which increases in proportion to the measured depth moving down from the surface because of the increasing weight of the water exerting downward force from above plus any pressure acting on the surface of the water, also decreases in proportion to the measured depth moving up from the bottom of the unit because of the decreasing weight of the water exerting downward force from above but still includes any pressure acting on the surface of the water in the storage tank, the loss or gain in hydrostatic pressure as the pump height is raised or lowered is essentially equal to the reduced or increased pressure needed to return the water to the storage tank 1, meaning the amount of electricity needed to run the pump 17 to return the pressurized water to the storage tank 1 will be about the same regardless of where it is located.

To better understand how the addition of compressed air into the upper part of the storage tank will affect the ability to return the water from the bottom of the unit back up and into the storage tank: If the top one foot of the upper part of the storage tank was filled with 300 psi compressed air and there was 100 feet between the surface of the water in the storage tank and the water at the bottom of the unit, a return pipe that was 800 feet high would be filled with over 770 feet of water. Put another way, if the top one foot of the upper part of the storage tank was filled with 300 psi compressed air, the increased pressure would be like adding more than another 650 feet of height to the typically 20 feet tall storage tank and filling it with water. And, of course, much higher than 300 psi compressed air can easily be used if needed to have the pump or pumps reach and maintain the targeted flow rate velocity of water through all the turbines in the coiled section of pipe.

The ability to use the overwhelming pressure provided by the compressed air in the upper part of the storage tank will have several important benefits. First among them, will be the ability to maximize the flow rate velocity of the water flowing down through all the turbines in the coiled section of pipe. This is because the overwhelming pressure applied to the surface of the water in the storage tank will not only make it possible to dramatically increase the flow rate velocity of the water flowing down through all the turbines in the coiled section of pipe, but it will also make it possible to dramatically increase the kinetic energy of the water and also dramatically increase the amount of energized water interacting with the turbines in the coiled section of pipe per minute. And with the kinetic energy of the water and the amount of energized water interacting with the turbines dramatically increased, the amount of electric power produced by all the turbines/generators in the coiled section of pipe per minute will also be dramatically increased.

As previously described, larger capacity (capacity meaning the amount of electricity that can be produced per hour) embodiments of the invention will require the utilization of many pumps to meet the large number of gallons of water that will need to be pumped back into the storage tank per minute and have the system operate as efficiently and cost-effectively as possible. This can easily be accomplished by determining the appropriate number of pumps needed to accommodate the intended volume of water rapidly exiting the bottom of the coiled section of pipe, then have that number of pumps either be coupled to a larger diameter and volume ground level section of pipe, or have that number of pumps be coupled to another large volume ground level conduit which will preferably include an airtight and watertight ground level tank or a similar water receptacle that is preferably coupled to the end of the coiled section of pipe, with the pumps, made considerably more efficient by the hydrostatic pressure of the water that will be at its peak at the bottom of the unit, then used to return the pressurized water back up and into the storage tank.

The objective of the invention to have more pumps or pumping capacity than needed for the power plant to operate at normal operating or nameplate capacity (which will be about 33% less than the targeted top capacity of the power plant), as well as having sister pumps or backup pumps included in the system, can also be accomplished without difficulty. In instances when at least one return pipe containing pressurized water loops up in the proper location and a pump is used to increase and control the flow rate velocity of the water through the main section of pipe, the addition of a sister pump can be done by having two branch pipes—or sister pipes—branch off each return pipe and extend up the distance needed to avoid any complications from the bend in the pipe. Each sister pipe will then have their own pump securely coupled to it that will be capable of returning the pressurized water through an upper return pipe the remaining distance into the storage tank. In instances when a pump or pumps are coupled to a larger volume ground level section of pipe or to a ground level tank, one or more backup pumps can be included among the pumps that are needed for the unit to reach full capacity. In either instance (or any other that is operationally possible), the Al-enabled control system will ensure that each pump is used and rested an equal amount of time, and predictive analytics will be able to detect any anomalies and irregularities and report them when found. And should one of the pumps need to be repaired or replaced—or just undergo routine maintenance—its sister pump or backup pump will be able to fill in full time without any interruption in electricity production by the power plant.

Routine maintenance of the turbines/generators will also be able to be accomplished without any interruption in electricity production by the power plant. This is due to how the power generation component of the turbine/generator will preferably be located outside the pipe, where it will be coupled to the pipe by means of a connector that is preferably in line with the turbine within the pipe and be able to be serviced—or even removed and replaced—without causing any water leakage and without causing any interruption in electricity production by the other still operating turbines/generators. Servicing or removing and replacing the turbine within the pipe will be a little more difficult but will be able to be done in some instances. This is because a watertight device will be able to be attached by a mechanic to the pipe above and around the section of pipe containing the means to remove the preferably helical turbine within the pipe. The watertight device will also have a pair of heavy-duty rubber gloves preferably built into it to assist the mechanic.

The use of helical turbines (which sort of look like the helix structure of DNA) over other types of in-pipe water turbines will primarily be due to their greater efficiency in harvesting the kinetic energy of the flowing water as it passes through the rotating blades of the helical turbine and drives a central rotating shaft. The central shaft will preferably have two ends that extend out from the main body of the turbine. One end of the central shaft will preferably connect to a water-tight connector (which will preferably have its own braking and locking system) that will also preferably connect outside the pipe to the rotating shaft of an electric generator. In numerous tests with published results, Gorlov helical vertical axis turbines (U.S. Pat. Nos. 5,451,137 and 5,642,984) have been able to extract up to 35% of the kinetic energy of moving water, even with the flow rate being as low as two meters-per-second. This percentage of efficiency will be about 30% greater than what can be achieved with more traditional fan and propeller type turbines with a similar amount of surface area when they are incorporated into in-pipe hydroelectric power systems. Gorlov helical turbines operate under a lift-based concept, so the water will sweep through the turbine as the turbine is harvesting the kinetic energy of the water flowing through it. Gorlov helical turbines also self-start, meaning they start to rotate when the water starts passing through them. Tests by researchers have also shown that Gorlov helical turbines can operate at high rotations-per-minute (rpms) with a nearly constant amount of torque (rotational force) and little vibration or water turbulence caused. Other tests have shown how Gorlov helical turbines have been able to extract up to 70% of the kinetic energy of moving water when appropriately curved inserts are placed within a conduit to channel fluid flow to the blades of the turbine, thereby increasing efficiency and power output. Helical vertical axis turbines can also be constructed in a wide variety of configurations that will reduce their water flow resistance and make them easier to be removed from the pipe. This is especially true when it comes to larger capacity embodiments of the present invention which may require that the turbines and generators be oriented horizontally. Another factor that may require the use of helical horizontal axis turbines instead of helical vertical axis turbines, will be the size of the generators and the accompanying gears or transmission or other means that will preferably be used in larger capacity units to assist in controlling the rpms of the turbines (more on this later).

With the level of efficiency and design of the helical turbines, the numerous benefits provided by natural forces, the compressed air in the upper part of the storage tank, the ability of the pumps to create a partial vacuum or lower pressure zone and use it to increase and control the flow rate velocity of the water through the helical turbines at whatever meters-per-second flow rate their gallons-per-minute pumping capacity is capable of providing, and the ability of the pumps to take full advantage of the hydrostatic pressure in the ground level tank or other large volume water receptacle at the bottom of the unit to operate normally while simultaneously returning the water up and into the storage tank very efficiently, the total number of appropriately spaced and sized turbines/generators that will preferably be utilized in the coiled section of pipe will have no difficulty producing much more electricity than the pumps will consume to return the pressurized water back into the storage tank. In fact, in large-scale embodiments of the invention, the efficiency of the power plant can easily be between 200% and 300% without even really trying—meaning between two and three times more surplus or net electric power will be produced per hour than the pumps will consume producing it. And with some of the efficiencies that are no doubt possible with some of the larger capacity embodiments of the invention, the cost of producing electricity over the long lifespan of the power plant can easily be less than one U.S. cent per kilowatt-hour, which will be quite remarkable for a 24/7, baseload, one-hundred percent clean energy power plant.

The materials that will be used to construct or manufacture the pipes or other conduits will also vary. Everything from plastics to synthetic materials, or from a wide variety of metals and metal alloys, to concrete or steel reinforced concrete, can and will likely be used along with any other material that can be used depending on the size of the unit and the required pressure rating.

The materials that will be used to construct or manufacture the support structures will also vary, running the gamut of potential building materials and methods. This will include the preferably tubular-shaped outer walls constructed around components of a power plant that will be located safely underground with the storage tank properly supported and resting on top.

In some instances, embodiments of the present invention will be incorporated into multi-use buildings such as apartment buildings, office buildings, stores, stadiums, hospitals, schools, warehouses, and many other structures, with the storage tank located above or being part of the roof and the coiled section of pipe preferably supported by support structures that are extensions of the main support structures for the rest of the building. By combining the power plant and the building together, building costs can be shared and the occupants of the building will have direct access to low-cost, one-hundred percent clean electric power for their one-hundred percent clean energy electric heating and hot water systems, as well as for the rest of their electricity needs. This mutually beneficial relationship—with the storage tank component being no more dangerous than the water towers found on the roofs of many tall buildings and the electricity generation and distribution system being no more dangerous than having large electric appliances—will also provide a long-term customer for the power plant and create all kinds of economic opportunities for occupants of the building and the local community.

In some instances, the invention will be incorporated into municipal and private infrastructure such as water, sewage, transportation and other types of infrastructure that will benefit immensely by having very low electricity costs. In fact, the invention will even have the potential to be incorporated into existing water towers to not only make them energy self-sufficient but turn them into clean energy microgrids that can sell their surplus electric power to further reduce costs and pay for needed repairs and upgrades.

In some instances, individual units of the invention will be grouped together to meet greater electricity needs. This will include as few as two or three individual units of the invention or as many as one hundred or more incorporated into a combined power plant. Of course, if additional space is available for expansion, additional units can always be added to meet growing electricity demand. The units that are grouped together will also come in different sizes, preferably beginning with those in the relatively small 2 to 6 MW (megawatt) range. And with a typical 6 to 9 MW unit of the invention having 10 feet diameter coils that occupy less than four square meters (or about a 13 ft. by 13 ft. plot of land), the amount of land needed to support a 500 MW power plant would be less than half an acre. In contrast, a 150 MW solar farm would need about 600 acres—or 4 acres for every 1 MW of solar panel capacity. A 6 to 9 MW unit of the present invention with 10 coils in the coiled section of pipe and an inside pipe diameter of 28 inches would also have a very reasonable height of about 85 feet, including the height of the storage tank, with the main section of pipe and the ground level tank preferably located underground if conditions permit.

Placing the main section of pipe underground will also make it possible for the units, which can be placed right next to each other, to share water and electric power distribution infrastructure at or near ground level to reduce costs. The excavated dirt can also be used to backfill around the circular outer support walls of each unit and reduce the depth below the original grade level that must be excavated, as well as raise the new grade level to prevent any possibility of flooding. Having the bottom of the storage tank cover most of the remainder of the unit below ground level will, in most cases, also prevent possible freezing of the liquid within the 28″ inside diameter pipes in the main section of pipe in a typical 85 feet high unit of the invention (20 ft. for the storage tank and 65 ft. for the pipes and ground level tank underneath), and also protect the most vulnerable parts of the unit against storms and other natural elements.

The 6 to 9 MW, roughly 85 feet high embodiment of the present invention, while not as powerful as some of the larger capacity units that may have a larger inside diameter pipe, will nevertheless have some important things in common with them. Namely, if each coil in the coiled section of pipe has an inside diameter of 10 feet, the length of the pipe in each coil will be 31.4 feet, which will result in the length of the ten coils in the coiled section of pipe being 314 feet. But more importantly, with an adequate amount of compressed air in the upper part of the storage tank, the multiple pumps, preferably connected directly to the ground level tank or other large volume water receptacle, will be able to maximize the flow rate velocity of the water passing through each of the 10 turbines in the 314 feet of pipe in the coiled section of pipe.

In addition to water and electric power distribution infrastructure, another important type of infrastructure that will preferably be located at or near ground level to reduce costs and can be shared by units of the present invention that are grouped together will have to do with the use of compressed air to supersede the beneficial effects of atmospheric air pressure throughout the system. Normally, the 14.7 psi of atmospheric air pressure at sea level would be sufficient to push the water in a vented storage tank down into the partial vacuum or lower pressure zone created by the impellers of the centrifugal pumps. However, because the flow rate velocity of the water flowing down through the helical turbines, as well as the amount of highly energized water interacting with the turbines per minute, will preferably be maximized in order to maximize the amount of kinetic energy that can be harvested and converted into electrical energy by the unit, by having the higher pressure compressed air essentially trapped in the upper part of an airtight and watertight storage tank, the flow rate velocity of the downward flowing water through the turbines in the coiled section of pipe will be able to be increased well beyond what can be achieved by gravity, atmospheric pressure and the siphon-like effect caused by the partial vacuum or lower pressure zone created by the pumps.

Moreover, because atmospheric pressure at sea level has a pressure of 14.7 psi, if the upper part of the storage tank is filled with 300 psi compressed air, the air pressure in the upper part of the storage tank will be more than 20 times greater than atmospheric air pressure. The 300 psi compressed air in the upper part of the storage tank will also be trapped there, so it will constantly be pushing the (essentially) incompressible water in the storage tank down through the turbines in the coiled section of pipe. And because it has nowhere to go, the constant pressure provided by the compressed air will be able to be maintained at minimal cost.

Of course, increasing the air pressure in the upper part of the storage tank in a very high capacity embodiment of the invention to an amount higher than 300 psi to increase the efficiency of the unit and help ensure its successful operation is certainly also possible. And with 800 psi of pressure sufficient to force water molecules through a reverse osmosis membrane and into a tank that has a pump creating a partial vacuum while simultaneously pumping the desalinated product water in the tank up to an onshore facility, if 800 psi or greater compressed air was needed in the upper part of the storage tank to maximize the flow rate velocity of the water down through the turbines in the coiled section of pipe and into the partial vacuum created by the centrifugal pumps that will preferably be simultaneously pumping the higher hydrostatic pressure water in the ground level tank into a return tank, where simple water displacement will then return an equal volume of water up into the storage tank regardless of how high it is, it could be done.

A pumped-hydro energy storage (PHES) system typically has an efficiency of 75% to 80%. That means 75% to 80% of the electricity that is needed to pump the water up to the higher elevation can be generated by a single turbine/generator on the return trip when the water is released back into the lower water source. But that 75% to 80% round-trip efficiency is achieved with the water needing to be pumped up the entire distance between the upper and lower water source. It is also achieved with the water flowing down through a pipe with most of the full effect of gravity accelerating the water until it reaches the single turbine/generator at the bottom. It is also achieved with the height between the upper and lower water source being at least 100 meters (328 ft.), and usually much more.

A 6 to 9 MW, roughly 85 feet high (20 ft. for the storage tank and 65 ft. for the pipes and ground level tank underneath), unit with 10 coils in the coiled section of pipe and an inside pipe diameter of twenty-eight inches will obviously not be anywhere near 100 meters (328 ft.) high. However, with roughly 331 feet of pipe in the main section of pipe, a unit with a coiled section of pipe with an inside pipe diameter of 28 inches will have the potential for the water within it to flow down through the entire coiled section of pipe at the same flow rate velocity as the velocity of water after falling straight down 50 meters if the pumps, preferably coupled directly to the ground level tank to further increase the efficiency of the system, can pump the pressurized water out of the airtight and watertight ground level tank at the same flow rate needed to produce a flow rate velocity through the coiled section of pipe that has the same velocity as the velocity of water after falling straight down 50 meters (164 feet).

That's right. As long as the pumps can pump the pressurized water out of the ground level tank at the same flow rate needed to produce a flow rate velocity equal to that of water falling straight down 50 meters, (approximately 31.3 meters-per-second or 70 mph), the water will be traveling through the coiled section of pipe at the same high velocity. This is important for several reasons: (1) When the discharge outlet pressure required to pump the water up into the storage tank (which is about ⅕^{th} as high using a 28″ inside diameter pipe if the main section of pipe is 100 meters long) at the desired flow rate is tabulated, it will be significantly less than the amount of discharge outlet pressure that would be required to pump the water up 100 meters. (2) Because of the hydrostatic pressure in the ground level tank due to the height of the water in the system and the additional air pressure from the compressed air in the upper part of the storage tank, and because multiple pumps will preferably be used to pump the pressurized water out of the ground level tank, and because the pressure of the water entering each pump after it is reduced by a comparatively small amount by the impeller while producing the partial vacuum or lower pressure zone needed for the pump to operate will be able to be subtracted from the discharge outlet pressure needed to pump the water up and into the storage tank at the desired flow rate, the amount of electric power needed to run the pumps will be dramatically reduced. (3) If the water flowing down through the turbines in the coiled section of pipe was traveling at the same velocity as water in a PHES system, a single turbine/generator within the coiled section of pipe with the water traveling at 31.3 m/s would be able to produce 75% to 80% (the generally accepted efficiency of a pumped-hydro energy storage system) of the electricity that a single PHES turbine/generator running in reverse would use if the quantity of water interacting with each turbine/generator per minute was the same and the efficiency of each turbine/generator was the same. (4) And even though the turbines/generators that will preferably be used with the present invention will only harvest and convert into electrical energy (conservatively) about 35% of the electric power that will be used by the pumps to maintain a targeted flow rate of 31.3 m/s through the entire coiled section of pipe, that about 35% will be generated by just one turbine/generator in the coiled section of pipe. There will preferably be at least ten coils in the coiled section of pipe of 28″ inside diameter pipe embodiments of the present invention, with at least one turbine/generator preferably in each of the ten coils—not to mention that more than ten coils are certainly possible in units with 28″ inside diameter pipes, or that coiled sections of pipe with other inside diameters are certainly possible and will be used.

What this also means is that about 35% of what it will cost in kilowatt-hours (kWh) and their monetary value to run the pumps will also be able to be produced by every one of the turbines/generators in the coiled section of pipe at the same time. Needless to say, having the ability to produce about 35% of the electricity that it will take to power the whole system with every turbine/generator in the coiled section of pipe and having so much surplus electric power available to use afterward will be pretty fantastic. The question then becomes, “How do you get the pumps to maintain the same flow rate velocity through the entire coiled section of pipe as what can be achieved by water falling straight down 50 meters?” The answer is actually quite simple.

To begin with, there is absolutely no doubt that a siphon-like, continuous flow of water can be caused by the partial vacuum or lower pressure zone created by the impellers of the centrifugal pumps that will preferably be coupled to the ground level tank or other water receptacle with an airtight and watertight connection and be used to increase and control the velocity of the water moving through the system. This can easily be conceptualized by a common human experience: As anyone who has ever bought a large beverage on a really hot day with a wider than normal and sturdier than normal straw will attest, after sealing their lips around the straw and drawing really hard on the straw to quench their thirst, the more so-called “suction” they apply to the cold beverage through the straw (which actually isn't suction because what they are doing is caused by the air pressure in their mouth falling below atmospheric pressure and atmospheric pressure simultaneously forcing the liquid to go up the straw and into their mouth in an attempt to fill the area of lower pressure), the more cold beverage they will be able to consume.

The ability of the pumps to create the partial vacuum or lower pressure zone needed to move the water through the system will work just as well, except the pumps will be able to do it continuously. And because the pumps will be securely coupled with an airtight and watertight connection to the ground level tank or other water receptacle, and because the hydrostatic pressure of the water in the ground level tank or other water receptacle will dramatically increase the efficiency of the pumps, and because of the benefits from gravity and momentum in moving the water down through the system, and because the rpms of the turbines will preferably be kept within a desired range by the high-wattage, high-torque generators and the Al-enabled control system (more on this later), and because the increased pressure from the compressed air in the upper part of the storage tank will constantly be pushing down with a more than adequate amount of pressure on the surface of the water within the storage tank to produce the top targeted flow rate velocity of water through all the turbines, there will just need to be enough pumps with enough pumping capacity to match the gallons-per-minute (gpm) flow rate needed to produce the top targeted flow rate velocity. Furthermore, if the pumps can match the pumping capacity needed to produce a flow rate velocity of 31.3 m/s—which will henceforth be used as the targeted flow rate velocity for the purpose of describing the power output of example units of the present invention with a 28″ inside diameter pipe in the coiled section of pipe (although much higher flow rate velocities are certainly possible in large capacity embodiments of the present invention with larger inside diameter pipes) and be about 33% greater than the normal operating flow rate velocity used to produce baseload electric power—they will have no difficulty maintaining the same flow rate velocity of water through the entire coiled section of pipe, making it possible to use all the turbines/generators in the coiled section of pipe to the greatest extent possible for that fairly substantial flow rate.

Having enough pumps and pumping capacity needed to match the gallons-per-minute flow rates needed to produce a flow rate velocity of 31.3 m/s will not be difficult, especially since multiple pumps, in a wide variety of readily available sizes, and having a wide variety of capabilities, will be used. For instance, if the unit's pumps need to pump roughly 197,000 gallons of water per minute up into the storage tank in order to simultaneously maintain a top targeted flow rate velocity of 31.3 m/s down through a coiled section of pipe with an inside pipe diameter of 28 inches and containing 10 turbines/generators, this can be accomplished by using common centrifugal pumps that connect directly to the ground level tank or other large volume water receptacle at the bottom of the unit. In addition to having the highest flow rates of all pump types (centrifugal pumps can reach flow rates of as high as 200,000 gpm), centrifugal pumps come in many types and configurations that can be used in a wide variety of applications. Centrifugal pumps are also the best pump choice for lower viscosity (thin) liquids and have horsepower (hp) ranges from 0.125 hp to 5,000 hp. But perhaps the most compelling reason to use centrifugal pumps located at the bottom of the unit will be because of the size and weight of the large capacity pumps and the opportunity they provide to take advantage of the large volume of highly pressurized water in the large volume ground level water receptacle, which will be at its highest pounds-per-square-inch (psi) pressure at the bottommost point within the unit.

Because hydrostatic pressure is produced by the elevation of water and will be measured by the height or vertical distance from the surface of the liquid in the storage tank down to the mid-point of the eye of the impeller, the ideal place to locate the centrifugal pumps is connected directly to the side or sides of the ground level tank or other large volume water receptacle using the multiple ports provided. With the distance between the top of the storage tank and the bottom of the unit being no more than 85 feet (20 ft. for the tank and roughly 65 ft. for the pipes and ground level tank underneath) in the previously described (first example) unit with a 28″ inside diameter pipe, 30,000 gpm centrifugal pumps with an adequate amount of pump head—or the difference between the suction head (or the pressure at the pump inlet) and the discharge head (or the pressure that is required at the pump outlet to return the water to the storage tank at the desired flow rate) will be efficient to run and be used in the example units to be described. Moreover, using 30,000 gpm centrifugal pumps will not only make it possible for seven 30,000 gpm centrifugal pumps to constantly pump 197,000 gallons of water up into the storage tank per minute with no difficulty, but to also create the partial vacuum or lower pressure zone that will provide the necessary conditions for hydrostatic pressure, which will include the pressure of the compressed air in the upper part of the storage tank and the water pressure due to the height of the water in the system, to be used as operational pressure to constantly push 197,000 gallons of highly pressurized water per minute into the suction side of the pumps with no difficulty.

Before showing how the flow rate velocities in meters-per-second (m/s) and the amount of surplus power in megawatts (MW) for several example units are determined, the first thing that will be shown is how the 31.3 m/s targeted flow rate velocity was determined. Of course, the easiest way to find out how fast an object will be traveling after falling straight down 50 meters would be to simply google it. But since this is a new technology and one of very few that can produce surplus electric power by combining natural phenomena with mechanical processes (as does Ocean Thermal Energy Conversion (OTEC) technology that is over 100 years old and has many approved patents related to the technology that have been granted over many years, including to the U.S. government and global corporations), we will do the math.

There are two simple equations that can be used to determine the time until impact and the speed at impact for an object falling due to the acceleration of gravity:

Height(h)=½ Gravity(9.8 m/s²)×Seconds-Squared (s² or s×s). (1)

h=1/2g×s².

50m=4.9 m/s²×s².

s²=50m÷4.9 m/s.

s²=10.2 seconds.
s=3.194 seconds, or the time until impact.

Velocity(v)=Gravity(9.8 m/s²)×Time(seconds). (2)

v=g×t.

v=9.8 m/s²×3.194 seconds.

v=31.3 m/s, or the speed at impact.

The greater the flow rate of water through the system, the greater the amount of kinetic energy that will be possessed by the water flowing through the coiled section of pipe and also the greater the amount of kinetic energy that can be harvested and converted into electrical energy by the turbines/generators. With the flow rate velocity of 31.3 meters-per-second being used as the targeted flow rate velocity, the next thing that needs to be determined is the amount of water in the main section of pipe of the first example unit with a 28″ inside diameter pipe.

1 cubic meter(3.28118 ft.×3.28118 ft.×3.28118 ft.)=35.325 cubic feet.

28″ inside diameter pipe=14.032 cubic feet of water per meter inside the pipe.
1000 kilograms (or 1 cubic meter of water)=2,204.62 lbs.
1 gallon of water=8.345 lbs.
1000 kilograms of water=264.18 gallons of water.

264.18 gallons(1000 kg or 1 cubic meter)of water÷35.325 cubic feet=7.478 gallons of water per cubic foot.

With 7.478 gallons of water in every cubic foot of area within a section of pipe and 14.032 cubic feet of water in every meter of length of the 28″ inside diameter pipe, the number of gallons of water in each meter of length, and also each 100 meters of length, of the 28″ inside diameter pipe can be calculated.
7.478 gallons per cubic foot×14.032 cubic feet of water in each meter of length of the 28″ inside diameter pipe=104.93 gallons of water in each meter of length of the 28″ inside diameter pipe. Also, 104.93 gallons×100 meters of pipe=10,493 gallons of water in each 100 meters of length of the 28″ inside diameter pipe.
And with the first 28″ inside diameter pipe example unit having a main section of pipe with a length of 331 ft., the volume of water in the main section of pipe can be rounded up from 10,493 gallons to 10,500 gallons (100 meters=328 feet).
Therefore, with the approximate amount of water known in the main section of pipe for the first 28″ inside diameter pipe example unit (10,500 gallons), the water flow rate velocity for the unit can be calculated:

197,000 gpm÷10,500 gallons of water in the main section of pipe=18.76 cycles per minute.

60 seconds÷18.76 cycles=3.2 seconds to complete each cycle.

100 meters÷3.2 seconds=31.25 m/s for the flow rate velocity of water through the main section of pipe.

In order to calculate the capacity (the number of megawatts of electric power produced by each example unit per hour) it is best to start by determining the potential energy possessed by the water within the system. This can easily be done using the formula E=m*g*h where:

E=energy produced in joules (J).
m=mass of water in kilograms (kg).
g=gravity (9.8 m/s²).
h=height in meters (m).
Using the formula E=m*g*h, it has been well established by the scientific community that the potential energy stored in raising 1000 kg (or 1 cubic meter) of water by 1 meter (1000 kg×9.8 m/s²×1 m) is equal to 9,800 J. And since 1 kilowatt-hour (kWh) equals 3,600,000 J, 9,800 J÷3,600,000 J=0.00272 kWh of stored potential energy by raising 1000 kilograms (or approximately 264.18 gallons of water) 1 meter (or approximately 3.28 ft.).
Therefore, the potential energy stored in raising 1000 kg of water 50 meters (1000 kg×9.8 m/s²×50 m) will be 490,000 J and be equal to 0.136 kWh (490,000 J÷3,600,000 J=0.136 kWh), or the estimated amount of kinetic energy possessed by each 1000 kg—or approximately 2,200 pounds—of water traveling at our targeted flow rate velocity of 31.3 m/s).
Using 197,000 gallons-per-minute for the volume of water pumped back into the tank per minute: 197,000 gpm÷264.18 gallons of water (1000 kilograms=264.18 gallons of water) equals 745 times 1000 kg goes into 197,000 gpm.
745 times per minute×0.136 kWh equals 101 kWh of kinetic energy possessed by the water passing through each turbine per minute (or 745,000 kg×9.8 m/s²×50 m=365,050,000 J, and 365,050,000 J÷3,600,000 J=101 kWh).
With a total of 101 kWh of kinetic energy passing through each turbine per minute with 197,000 gallons of water cycling through the system per minute, the next number that needs to be determined is the amount of kinetic energy possessed by the moving water that can be harvested and converted into electrical energy by each turbine/generator per minute. Since we know from published research that Gorlov helical turbines can extract up to 35% of the kinetic energy of moving water, we can then calculate:
101 kWh×33% (the efficiency of the helical vertical axis turbines used in this example unit—and also despite how using curved inserts can produce an efficiency of up to 70%) to determine that 33.33 kWh of energy can be extracted by each turbine per minute.
Then, since we know the generally accepted efficiency for current turbine-powered generators is approximately 80%, we can calculate:

33.33 kWh×80%(efficiency of generator)=26.7 kWh of electric power produced by each turbine/generator per minute.

26.7 kWh of electric power produced per minute×60 minutes equals 1,602 kWh of electric power produced by each turbine/generator per hour.
1,602 kWh of electric power produced by each turbine/generator per hour×10 turbines/generators in the coiled section of pipe equals 16,020 kWh of electric power produced by the 10 turbines/generators per hour.
With the total amount of electricity that the 10 turbines/generators can produce per hour determined, the next number that needs to be determined is the amount of electricity that will be consumed per hour by the seven 30,000 gpm centrifugal pumps to ensure a steady flow of water of at least 197,000 gpm through all 10 turbines/generators. With the help of our local pump distributor, we were able to learn that a 30,000 gpm centrifugal pump with a more than adequate amount of pump head to return roughly 28,000 gallons of water into the storage tank per minute will need about 980 kWh of electricity to run for one hour.

980 kWh×7 pumps=6,860 kWh.

Therefore: 16,020 kWh (the electricity output of 10 turbines/generators per hour) minus 6,860 kWh (the electricity input to power seven pumps per hour) equals 9,160 kWh of surplus electricity produced by the first 28″ inside diameter pipe example unit per hour.

9,160 kWh÷1000(1 MW=1000 kWh)equals 9.16 megawatts(MW)of electric power capacity for the unit.

In some embodiments, water distribution capabilities will be incorporated into the system. A water tower is an elevated structure supporting a water tank that is constructed at a height sufficient to pressurize a water supply system for the distribution of potable (drinking) water. Water towers are able to supply water even during power outages because they rely on hydrostatic pressure produced by the elevation of water (due to gravity) to push water into domestic and industrial water distribution systems. However, they cannot supply the water for a long period of time without power because a pump is typically required to refill the tank.

Although the use of elevated water storage tanks has existed since ancient times in various forms, the modern use of water towers for pressurized public water systems was developed during the mid-19th century. A wide variety of materials can be used to construct a typical water tower. In most cases, steel and reinforced or pressurized concrete are normally used. Specialized interior coatings are also usually incorporated to protect the water from any adverse effects from the lining material. The reservoir in the tower may be spherical, cylindrical, ellipsoid, or be constructed in another shape that usually has a minimum height of approximately 6 meters (20 ft.) and a minimum diameter of 4 meters (13 ft.). A standard water tower also typically has a height of approximately 40 meters (130 ft.).

In regard to the present invention, what this means is that with the bottom of the storage tank elevated 34 meters (or roughly 112 feet), the electricity generating capacity of the unit will also be increased when compared to the first example unit using a height of roughly 65 ft. for the distance below the storage tank. With an additional 47 ft. of vertical distance to work with than the first example unit, by simply doubling the number of coils in the coiled section of pipe from 10 to 20, the number of turbines/generators in the coiled section of pipe can also be doubled from 10 to 20 and the capacity of the unit will actually be more than doubled. This is because the 132 feet height (20 ft. for the tank and 112 ft. for the pipes and ground level tank underneath) of the unit will increase the hydrostatic pressure of the water in the ground level tank by roughly the same amount that the discharge outlet pressure of the 30,000 gpm pumps need to be increased to return the highly pressurized water to the storage tank at the desired flow rate. And by doubling the length of the main section of pipe from roughly 100 meters with a water volume of roughly 10,500 gallons to roughly 200 meters with a water volume of roughly 21,000 gallons, and also the number of turbines/generators in the coiled section of pipe from 10 to 20, the 9.16 MW capacity of the first example unit will be more than doubled to more than 25 MW in a 132 ft. high water tower and water distribution unit because the amount of electric power used to return the water up into the storage tank will be roughly the same (or even a little less) using the return tank.

197,000 gpm÷21,000 gallons in 200 m pipe=9.38 cycles per minute.

60 seconds÷9.33 cycles=6.4 seconds per cycle.

200 m÷6.4 seconds=31.25 m/s.

197,000 gpm÷264.18(1000 kg or 1 cubic meter of water)equals 745 times 1000 kg goes into 197,000 gpm.

0.136 kWh×33%×80% efficiency of each turbine/generator=0.036 kWh.

0.036 kWh×745=26.82 kWh turbine/generator output per minute.

26.82 kWh×60 minutes=1,609.2 kWh output per hour.

1,609.2 kWh×20 turbines/generators=32,184 kWh output per hour.

980 kWh(electricity to run pump for 1 hour)×7 pumps=6,860 kWh input of electricity per hour for seven pumps.

32,184 kWh minus 6,860 kWh=25,324 kWh surplus per hour.

25,324 kWh÷1000=25.3 MW of capacity for the unit.

But why stop there? Since the main section of pipe height will be doubled, why not double the diameter and circumference of each coil in the coiled section of pipe as well? By doubling the coil diameter from 10 ft. to 20 ft., the circumference of the pipe in each coil will also double from 31.4 ft. to 62.8 ft. And by doubling the circumference of each of the 20 coils in the coiled section of pipe from 31.4 ft. to 62.8 ft., the roughly 200 meters of 28″ inside diameter pipe with a water volume of roughly 21,000 gallons that extends from the bottom of the storage tank to where the end of the coiled section of pipe connects to the ground level tank, will be doubled from roughly 200 meters to roughly 400 meters, with the water volume within the main section of pipe becoming roughly 42,000 gallons.

197,000 gpm÷42,000 gallons in 400m pipe=4.69 cycles per minute.

60 seconds÷4.69 cycles=12.8 seconds per cycle.

400m÷12.8 seconds=31.25 m/s.

The doubling of the overall length of the main section of pipe from roughly 200 meters to roughly 400 meters, as well as the doubling the circumference of each coil in the coiled section of pipe from 31.4 ft. to 62.8 ft., will also make it possible to add an additional turbine/generator to each of the twenty coils in the coiled section of pipe and still have roughly 30 feet of pipe between each turbine/generator. That means that instead of having 20 turbines/generators to produce electricity in the roughly 106 ft. high main section of pipe, there will be 40 turbines/generators available to be used to produce electricity, and do so, using the same seven 30,000 gpm centrifugal pumps, to once again more than double the capacity of the unit. But this time the estimated capacity of the unit will increase from an already impressive over 25 MW of baseload electric power produced 24/7, to over 57 MW.

197,000 gpm÷265.18=745.

0.272 kWh×33%×80%=0.036 kWh.

0.036 kWh×745 times=26.82 kWh output per minute per turbine/generator.

26.82 kWh×60 minutes=1,609.2 kWh output per hour.

1,609.2 kWh×40 turbines/generators=64,368 kWh output per hour.

980 kWh×7 pumps=6,860 kWh.

64,368 kWh minus 6,860 kWh=57,508 kWh.

57,508÷1000=57.5 MW of capacity for the unit.

Naturally, units of the present invention with larger overall length and height main sections of pipe, as well as larger diameter coils and numbers of coils, are possible and will surely be constructed above and below ground, or a combination of both. Similarly, even bigger turbines and generators will surely be needed in units with wider than 28″ inside diameter pipes in their main sections of pipe. Likewise, higher capacity units will almost as surely need larger capacity pumps to produce the high flow rate velocities that will be needed to take full advantage of the larger volumes of water in units with larger inside diameter pipes in the main section of pipe.

In regard to the sizes of the pumps and how effective they will be in accomplishing the objectives of the present invention: experiments were conducted to test different sized pumps in different situations. To make a long story short, the overwhelming conclusion after conducting all these different tests is that the size of the pump doesn't affect—at all—the basic purpose of the pump to draw water in one end and propel or push it out the other end at whatever flow rate it is capable of producing. As long as there is a constant supply of pressurized water into the pump, whatever volume of water the pump that was being tested pumped the water up to the higher elevation, the same volume of water per minute flowed down through the entire main section of pipe.

Another way to maximize the efficiency and the potential capacity of a unit of the present invention will be to add one or more main sections of pipe to the bottom of the storage tank along with the additional pumping capacity needed to maintain the targeted flow rate velocity through all the turbines, which includes adding more pumps to the ground level tank or other large volume water receptacle. Since the storage tank will already be elevated and supported above the pipe portion of the unit, adding additional main sections of pipe will be relatively easy to do. The hardest part will be in deciding how to arrange the multiple main sections of pipe so they don't interfere with each other. This can be done in any number of ways. They include: (1) Locate a down-pipe closer to the edge on either side of the storage tank and have half the coiled section of pipe extend out from the edge of the bottom of the tank. (2) Locate four down-pipes and their coiled sections of pipe equally spaced apart under the storage tank. But regardless of how it is done, since the storage tank and how it is supported will be the most expensive aspect of the unit, adding one or more additional main sections of pipe will make economic sense. This includes having one or more of the additional main sections of pipe being a straight, vertical section of pipe that includes enough turbines/generators to produce surplus electric power, or adding a straight, vertical section of pipe to a shorter coiled section of pipe with each including enough turbines/generators in total to produce surplus electric power. In either case, a separate ground level tank with an adequate number of pumps will make it possible for either, or any other main section of pipe that is possible that can be used to produce surplus power, to be used to produce electric power when desired.

Another way that will be used by the present invention to maximize the efficiency and the potential capacity of a unit will be to use Artificial Intelligence (Al) and Machine Learning (ML) technologies. By turning every pump, motor, valve, turbine, generator, variable frequency drive or variable speed drive, inverter, transformer and control system into a smart device, the efficiency of the entire system will typically be increased by at least 5%, and probably more. Moreover, by using smart sensors to monitor every device and aspect of the unit, any anomalies and irregularities will be reported and be able to be immediately addressed, potentially saving very costly repairs. Also, using Al technologies for cybersecurity purposes will not only help reduce the possibility of a debilitating cyberattack, but will lower the cost of expensive cybersecurity services as well. But potentially even more important, Al and ML technologies will make it possible for the unit to automatically produce the amount of electricity that is requested or desired.

Having the ability to produce any amount of electricity within the total capacity of the unit at any time will be extremely beneficial. This will be especially true on really hot or really cold days when electricity demand can push the electric grid to its limits. In such instances, the 33% of extra capacity above nameplate capacity, which will preferably be built into every decent-sized unit of the invention, will be able to be utilized. How the 33% of extra capacity will be accomplished will be to simply have the nameplate, or normal operating, capacity of the unit be reduced by having the variable frequency drives (AC power) or variable speed drives (AC power or DC power), which will preferably be used to control the speed of the motors of the pumps, maintain the flow rate velocity of the water down through the main section of pipe at, for instance, approximately 28.7 meters-per-second instead of the previously top targeted flow rate velocity of approximately 31.3 m/s.

A 28.7 m/s normal operating flow rate velocity for the downward flowing water will be close to the velocity an object would be traveling at impact after falling straight down 42 meters due to the acceleration of gravity. And the amount of kinetic energy possessed by the 28.7 m/s (or 64 mph) moving water that can be harvested and converted into electrical energy per minute by each turbine/generator in the coiled section of pipe in units with a 28″ inside diameter pipe will be about 33% less than if the flow rate velocity of the water was 31.3 m/s (or 70 mph).

The 33% reduction from the higher targeted capacity of the unit to the normal operating capacity will equate to: (1) the 85 ft. high example unit with 10 coils, 10 turbines/generators and a 28″ inside diameter pipe having its hourly output reduced from 9.16 MW to 6.14 MW, (2) the 132 ft. high example unit with 20 coils, 20 turbines/generators and a 28″ inside diameter pipe having its hourly output reduced from 25.3 MW to 16.85 MW, and (3) the 132 ft. high example unit with 20 coils, 40 turbines/generators and a 28″ inside diameter pipe having its hourly output reduced from 57.5 MW to 38.33 MW. And while these reductions are substantial, the calculations for the example units were done with the efficiency of the Gorlov helical turbines being 33%. As described previously, tests have shown that Gorlov helical turbines have been able to extract up to 70% of the kinetic energy of moving water when appropriately curved inserts are placed within a conduit to channel fluid flow to the blades of the turbine, thereby increasing efficiency and power output.

When Gorlov or other helical vertical axis turbines are used by the present invention, if the curved inserts are used the two curved inserts will preferably be placed opposite each other along the sidewalls of the pipe. Conversely, when Gorlov or other helical horizontal axis turbines are used the two curved inserts will preferably be placed opposite each other along the top and bottom of the pipe. The curvature of the insert comprises a circular arc, one near the leading edge of the turbine and the other near the retreating edge, with the curved sections meeting along a V-shaped point as close to the trajectory of the blades as possible to provide minimal clearance between the blades and the pipe. And obviously, if the inserts are used and increase the efficiency of the helical turbines from 33% to 66%, the capacity of all the example units when operating at the normal operating capacity will also be doubled, which will definitely be quite an improvement.

While certainly not as impressive as being able to double the capacity of a unit, another way to increase the efficiency and the amount of surplus electric power a unit of the present invention will produce per hour will be to use larger capacity pumps and the variable frequency drives or variable speed drives, which will preferably be used to control the speed of the motors of the pumps, to significantly reduce the amount of electricity used by the pumps during the normal operation of the unit. Because the electric power a pump motor consumes is directly proportional to the cube of its velocity, if a pump is run at 80% of full speed it theoretically uses 51% of full load power. It also means, if a pump is run at 70% of full speed, including the power needed to run the variable frequency drives or variable speed drives, the power consumption will be reduced by at least 60%. For example, and because smaller capacity pumps may be included among the pumps used by a unit to efficiently meet different power outputs, if a 10,000 gpm pump being run at full speed is replaced with a 16,750 gpm pump run at 70% of full speed, the 10,000 gpm pump and the 16,750 gpm pump will each have a pumping capacity of about 10,000 gpm. But because the 16,750 gpm pump will be run at 70% of full speed and use no more than 40% of the roughly 525 kWh of electricity it would consume at full speed per hour, the 16,750 gpm pump will only use about 210 kWh (525 kWh×40%=210 kWh) per hour to constantly pump 10,000 gpm through the system. In contrast, the 10,000 gpm pump run at full speed would consume about 280 kWh to constantly pump 10,000 gpm through the system per hour. Naturally, if something similar was done with all the pumps used by the unit, using about 25% less electric power to operate the whole system per hour would be a meaningful improvement. Having the extra pumping capacity available in each pump would also be nice to have for any number of reasons.

Among the most prolific energy producing embodiments of the present invention will be those that operate in large bodies of water, such as oceans and seas. Among their most impressive features will be their potential ability to have their coiled section of pipe extend down large distances. Another impressive feature will be their ability to return the water back to its source quite easily and efficiently. This is because after the water enters the unit from the surrounding body of water, be it at the surface or at a lower depth, the hydrostatic pressure of the water in the bottom tank at the bottom of the unit will be the same as the hydrostatic pressure of the water outside the bottom tank in the surrounding body of water at the same depth below the surface.

### BRIEF DESCRIPTION OF DRAWINGS

FIG. 1 shows a side view of the elevated storage tank with the tank release valve below the storage tank and the top of the down-pipe below the tank release valve.

FIG. 2 shows a side view of the down-pipe with the short initial top piece of the coiled section of pipe extending out from the bottom of the down-pipe and leading to several coils of the coiled section of pipe.

FIG. 3 shows a side view of a turbine/generator oriented vertically within and atop the first coil of a coiled section of pipe.

FIG. 4 shows a large side view of the turbine, connector and generator.

FIG. 5 shows a side view of the ground level section of pipe.

FIG. 6 shows a side view of the main section of pipe, which includes the downpipe, coiled section of pipe and the ground level section of pipe, as well as a single turbine/generator in the ground level section of pipe.

FIG. 7 shows a side view of the storage tank supported underneath by the support column and the angled top piece.

FIG. 8 shows an overhead view of the support column with four support arms attached to it and a coil of the coiled section of pipe.

FIG. 9 shows an overhead view of five circular outer support walls.

FIG. 10 shows an overhead view of a circular outer support wall with four support arms.

FIG. 11 shows an overhead view of five circular outer support wall and one large storage tank on top of the five circular outer support walls.

FIG. 12 shows a side view of a unit of the invention with a smaller water receptacle below the main storage tank for the pressurized water from the return pipe to flow freely into due to hydrostatic pressure and atmospheric air pressure. A second return pipe extends up from the smaller water receptacle to the main storage tank.

FIG. 13 shows a side view of a small capacity unit of the invention with two return pipes, each with an elevated pump attached to the return pipe at a height near the top of the coiled section of pipe.

FIG. 14 shows a side view of a pair of sister pumps attached to the tops of a pair of sister pipes that branch off a larger diameter return pipe.

FIG. 15 shows a side view of a large volume ground level pipe.

FIG. 16 shows a side view of a large volume ground level tank.

FIG. 17 shows a side view of a unit with a ground level tank and a return tank.

FIG. 18 shows a side view of a top of a unit of the invention that is located in a body of water, including the floating surface level structure, the down-pipe, and the top of the coiled section of pipe.

FIG. 19 shows a side view of unit of the invention that is located in a body of water with guide wires or cables that extend from the floating surface level structure down to concrete anchors.

FIG. 20 shows a chart of the hydrostatic pressure at certain depths from 1 meter to 10 meters.

FIG. 21 shows a chart of the hydrostatic pressure at certain depths from 10 meters to 5000 meters.

FIG. 22 shows a side view of a unit of the invention that is located below the surface in a body of water and held vertical by an balloon.

### DETAILED DESCRIPTION OF THE INVENTION

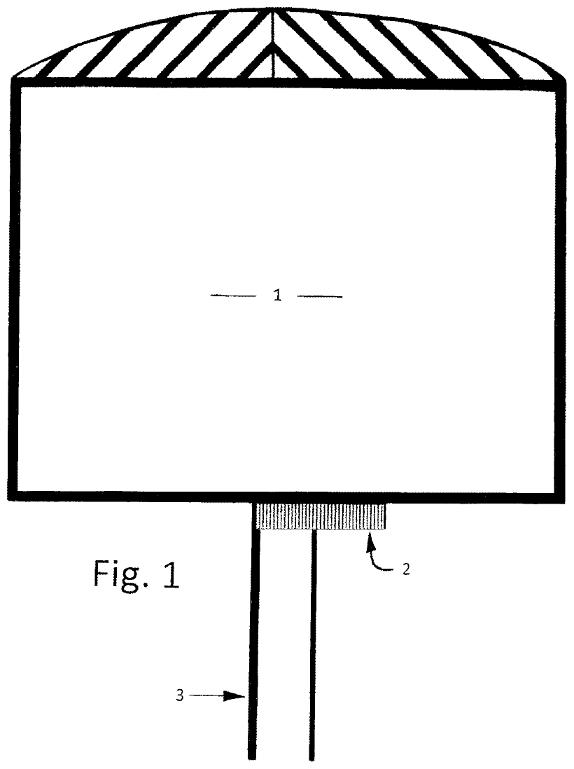

None of the parts in the drawings are to scale or are necessarily in proportion to those that may be found in an operational unit of the present invention. In some instances, certain features may be exaggerated in order to better illustrate and explain the present invention. All the parts shown are only intended to clearly convey the concepts and basic principles involved. Also, for clarity and simplicity's sake, some connections and structural supports and other components, as well as mechanical and electrical components and controls, are not shown. Furthermore, in the case of commonly known or generally understood parts that may be used in the successful operation of the invention, simple geometric shapes may be used at times to help depict them. The drawings are numbered consecutively beginning with 1 (example FIG. 1), as are the corresponding parts within the different views (examples: 1, 2, 3, 4, 5 . . . ).

As described previously, storage tank will relate in general to the elevated or upper water receptacle; tank release valve will relate in general to the mechanized valve system used to release water or stop the flow of water from the bottom of the tank; down-pipe will relate in general to the original section of pipe heading vertically straight down from the bottom of the tank; coiled section of pipe will relate in general to the coiled section of pipe between the down-pipe and the ground level section of pipe or the ground level tank at the bottom of the unit; return pipe or upper return pipe will relate in general to the pipe or pipes that will be used to return the water back up into the storage tank.

Water will be used to describe the liquid that will be used by the present invention unless a more descriptive term is deemed more appropriate. Turbine will be used to describe the device that will be used to harvest the kinetic energy of flowing water. Generator will be used to describe the device that will be used to convert the harvested kinetic energy that was turned into mechanical energy by the turbine into electrical energy. Connector or water-tight connector will be used to describe the device that will be used to connect the separate shafts of the turbine and the generator.

A unit of the present invention includes all the different parts that may be used for the invention to operate properly as a fully functioning power plant. The use of the term unit may also be used to describe any fully functioning embodiment of the present invention that may be combined with other units of the invention to produce a larger capacity power plant.

A cycle will be determined and correlate directly to the amount of water one or more pumps return over the course of a minute back into the storage tank or other source of the water. The capacity of a unit of the present invention will be described in megawatts (MW) of electric power produced per hour. The flow rate velocity of water through parts of the system will be described in meters-per-second (mps or m/s). The size and capacity of the pumps will be described in gallons-per-minute (gpm).

Gravity, hydrostatic pressure and atmospheric air pressure are natural forces that will continue to be beneficial and/or essential for the successful operation of different embodiments of the present invention described herein. The partial vacuum or lower pressure zone created by the pumps will continue to be used when describing how the pumps, when combined with the beneficial effects from gravity, air pressure (atmospheric or compressed) or mechanically produced pressure, and hydrostatic pressure, will be able to produce a steady (siphon-like) flow of water between the pumps and the water in the storage tank or other water source, with the flow rate velocity of the water controlled by the number of gallons-per-minute being pumped by the pumps that are coupled to suitable conduits that are used to return the pressurized water back to the storage tank or other water source.

And the coiled section of pipe, the compressed air in the upper part of the storage tank used to apply constant pressure to the surface of the water in the storage tank, using the pumps to return the water to the storage tank to produce a continuous flow of water through the system, attaching the pumps to the ground level tank or other conduit to create a watertight and airtight closed part of the system that extends from the pumps all the way back up to the surface of the water within the storage tank, using the pumps to increase and control the flow of water throughout the system, using the pumps to control the amount of electricity produced by the power plant, using the pumps to increase the flow rate velocity of water through all the turbines in the coiled section of pipe, using the compressed air to increase the flow rate velocity of water through all the turbines in the coiled section of pipe, using the compressed air and the pumps to increase the kinetic energy possessed by the water and the amount of energized water interacting with the turbines per minute, using the hydrostatic pressure of the water to increase the efficiency of the pumps and reduce the amount of electric power used to return the pressurized water to the storage tank, using the return tank and simple water displacement to efficiently return the water to the storage tank regardless of how high it is, and using gravity, momentum, the compressed air and the pumps to produce a flow rate velocity of water through the turbines at the top targeted flow rate velocity of approximately 31.3 meters-per-second (although higher flow rate velocities are certainly possible), will continue to be some of the important elements and innovative new concepts that are at the heart of the FFWN Clean Energy Power Plant.

An embodiment of an invention is a particular instance of the invention, an example of one of the various ways in which the invention may be realized or implemented. Embodiments are also used in the specification and claims to maximize the scope of protection claimed in the patent.

There are many different potential embodiments of the present invention. They include embodiments of the present invention that are land-based, as well as embodiments of the present invention that operate within bodies of water. Other embodiments of the present invention may even be used as a power source for spacecraft in space.

Starting with embodiments of the present invention that are located on land, they will preferably make use of an elevated water source such as a well-constructed water storage tank 1 (see FIG. 1). The elevated storage tank 1 will provide both a source for the downward flowing water that will be used to generate electricity by the invention and, by taking advantage of the natural force of gravity, use the water in the elevated storage tank 1 to produce hydrostatic pressure in the airtight and watertight portions of a unit below the surface of the water in the storage tank 1. In addition, proper venting of the storage tank 1 to the outside atmosphere will also make it possible for the water within the storage tank 1 to facilitate the beneficial effects of atmospheric air pressure throughout the system. Similarly, by making the inside of the storage tank 1 airtight and watertight, the pressure being applied to the water within the storage tank 1 can be increased by introducing a compressed gas (preferably compressed air) or by using mechanical means, with the pressure applied to the surface of the water in the storage tank 1 also increasing the hydrostatic pressure of the water within the system by a commensurate amount.

In regard to the location of the storage tank 1, numerous embodiments of the present invention are possible. They include configurations in which the storage tank 1 is raised at different heights above ground level in order to maximize the amount of hydrostatic pressure and electric power that can be produced. Other configurations will have the storage tank 1 located at or below ground level.

At the bottom of the storage tank is a mechanized tank release valve 2. The preferably electric-powered tank release valve 2, will be capable of being used to release and stop the flow of water out of and down from the bottom of the tank 1. This will be especially useful in potential embodiments of the invention that rely primarily on the beneficial effects of the natural forces of gravity, hydrostatic pressure and atmospheric air pressure to produce surplus electric power.

After passing through the release valve 2, the initial downward flow of water will be straight down through the down-pipe 3. The down-pipe 3, which may be coupled to the bottom of the tank 1 in addition to being coupled to the release valve 2, will preferably extend vertically straight down approximately 20% of the total distance between the bottom of the storage tank 1 and the bottom of the unit. This will continue to be the case until the length of the down-pipe 3 becomes sufficient for the height of the unit, including in instances when the bottom of the unit is at or below the surrounding ground level.

One reason why the down-pipe 3 will extend straight down vertically at first is so the downward flowing water will have an opportunity to accelerate as fast as possible due to the force of gravity after it exits the storage tank 1. Another reason the down-pipe will preferably extend straight down vertically at first is because it will give the invention a chance to mechanically accelerate the water to the desired or targeted flow rate velocity before it is used to start generating electricity. Having the down-pipe 3 have a larger inside diameter at the top than at the bottom will also help to increase the velocity of the downward flowing water.

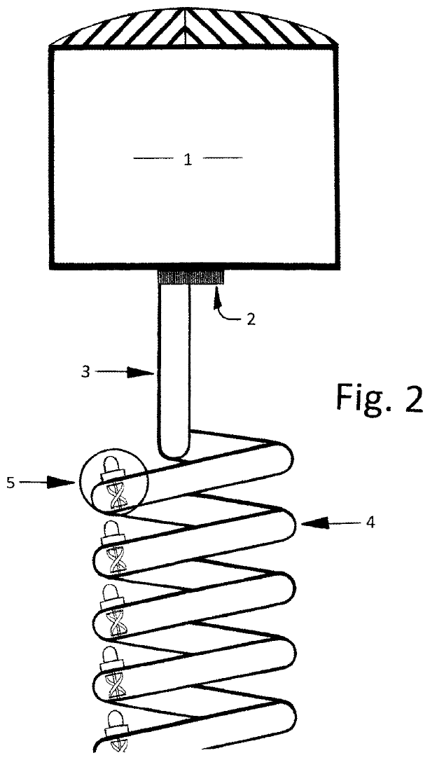

The down-pipe 3 ends its vertical path straight down by turning horizontally and connecting to the top of the coiled section of pipe 4 with a short piece of pipe that begins the coiled section of pipe's gradual advance downward (see FIG. 2).

In embodiments of the present invention that rely primarily on the natural forces of gravity, atmospheric pressure and hydrostatic pressure to produce a steady flow of water through the coiled section of pipe 4, the down-pipe 3 and the coiled section of pipe 4 will preferably both be made of the same material and have the same inside diameter pipe. The down-pipe 3 and the coiled section of pipe 4 will also preferably be made in one continuous piece with no seams or connectors. This could potentially be done by being constructed using the most advanced and cost-effective 3D printing technology available.

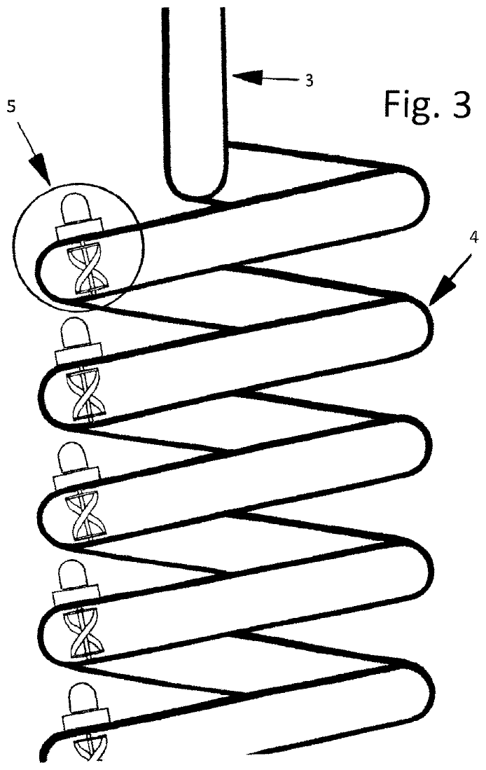

As shown in FIG. 2 and in a larger view in FIG. 3, each coil of the coiled section of pipe 4 will preferably include at least one combined turbine/generator 5 unit for harvesting the kinetic energy of the flowing water and converting it into electrical energy.

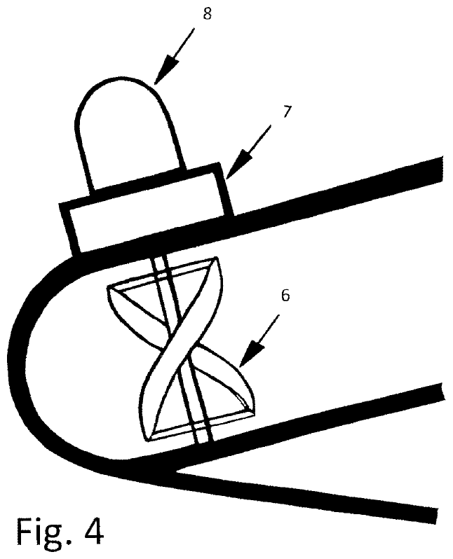

In smaller capacity units of the present invention each turbine/generator 5 will primarily and preferably be comprised of a helical vertical axis turbine 6, a watertight and airtight central connector 7, and a shaft-driven rotary generator 8 (see FIG. 4). In addition to preferably having a female end (not shown) on either side of the central connector 7 for the opposing shafts of the turbine 6 and the generator 8 to be connected in a watertight and airtight manner, the central connector 7 will preferably have braking and locking capabilities (also not shown).

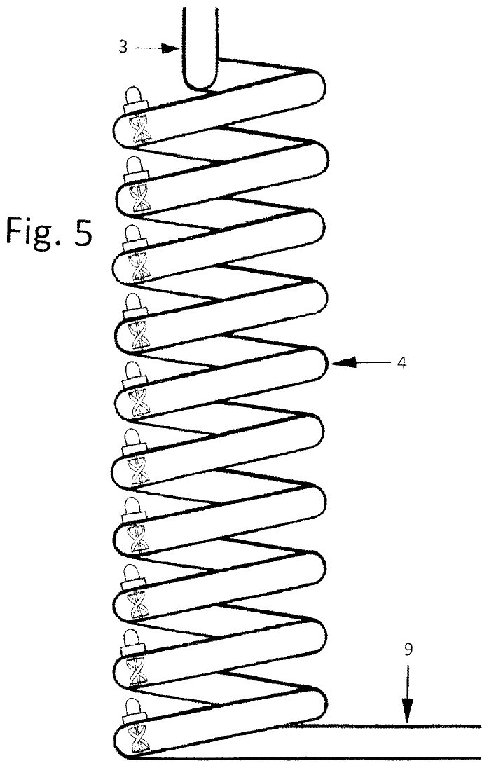

By using the coiled section of pipe 4, the overall length of the three main sections of pipe extending down from the bottom of the tank 1 (see FIG. 5) can easily be increased by ten times when compared to the total allotted distance between the bottom of the tank 1 and the bottom of the ground level section of pipe 9.

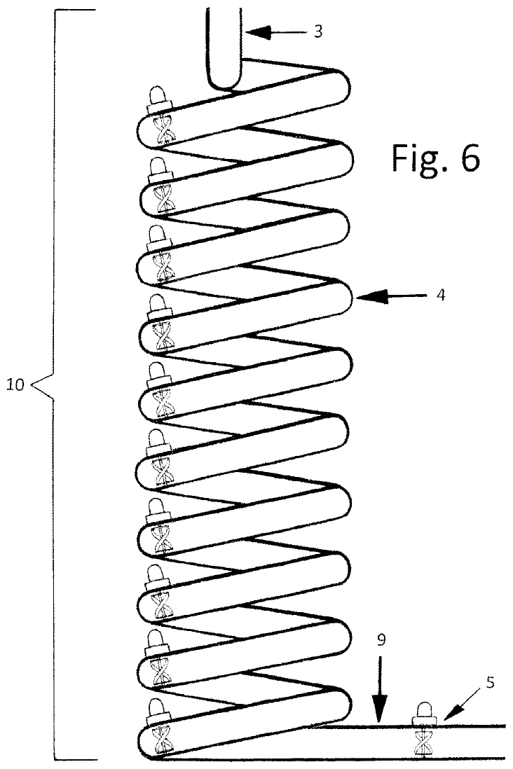

For brevity and simplicity's sake, any combination of the three main sections of pipe (which include the down-pipe 3, the coiled section of pipe 4, and the ground level section of pipe 9) will be described at times as the main section of pipe 10 (see FIG. 6).

In less powerful embodiments of the present invention that rely primarily on natural forces to produce electric power, as with how the municipal water lines that branch out from a water tower can extend for miles and still provide pressurized water to homes and businesses, if a single section of pipe is coupled to the end of the coiled section of pipe, it will contain pressurized water that can be used to do more than just increase how efficiently the water is returned to the original source. That includes having the ground level section of pipe 9 run horizontally along various paths in order to extend the overall length of the main section of pipe 10 and the number of turbines/generators 5 that can be used to generate electricity. One such configuration (as also shown in FIG. 6), includes adding at least one turbine/generator 5 for generating electricity to the ground level section of pipe 9. Another configuration (or embodiment) that could be used to add one or more turbine/generators 5 would be to add a straight, vertical section of pipe (not shown) to the end of the coiled section of pipe.

The weight of the water within the coils of the coiled section of pipe 4—especially in larger embodiments of the present invention—will require the use of external structural supports in many instances. Determining how the coils in the coiled section of pipe 4 will be supported by the external structural supports will depend primarily on whether the coils in the coiled section of pipe 4 are elevated above the surrounding ground level or located below the surrounding ground level.

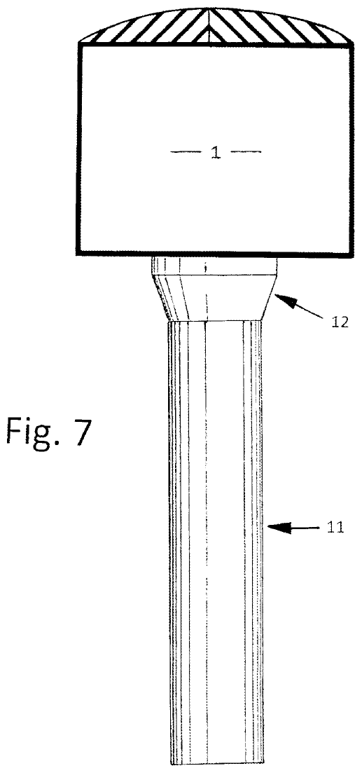

In instances when the coils of the coiled section of pipe 4 are located above the surrounding ground level, because the storage tank 1 will preferably be supported by a centrally located support column 11 (as shown in FIG. 7), the pipe-like steel support column 11—which will have an angled top piece 12 to help better balance the weight of the tank 1 and provide more room for the tank release valve 2 and for a wider diameter top of the down-pipe 3 in instances when a wider diameter top than the bottom of the down-pipe 3 is utilized—will also be able to be used to support the individual coils of the coiled section of pipe 4.

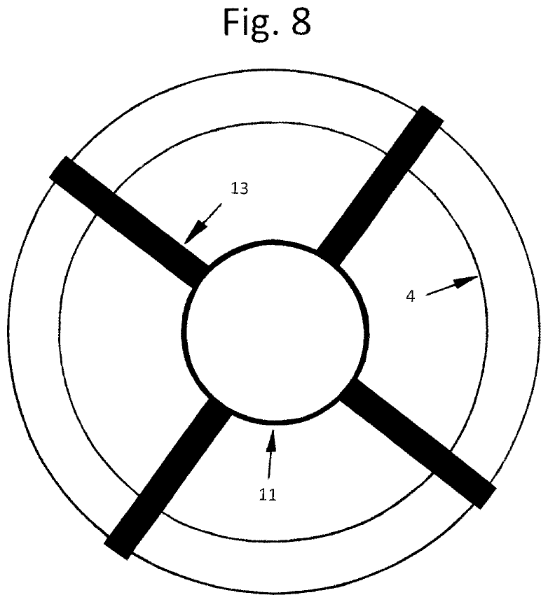

By preferably connecting four rows of steel support arms 13 (although more are certainly possible) to the side of the steel support column 11 to support each coil of the coiled section of pipe 4 in four equally spaced locations (see FIG. 8), the weight of the water in each of the coils will be adequately supported. Naturally, the larger the inside diameter of the pipe and the circumference of the coils in the coiled section of pipe 4, the larger and more robust the support arms 13 will be made.

In instances when the coils of the coiled section of pipe 4 are located above and below the surrounding ground level, because the storage tank 1 will still be elevated and need to be supported, the centrally located steel support column 11 will preferably be used once again to perform the dual role of supporting the storage tank 1 and providing a strong structure from which to connect the steel support arms 13, which will preferably be used to support the remainder of the coils in the coiled section of pipe 4 below ground level.

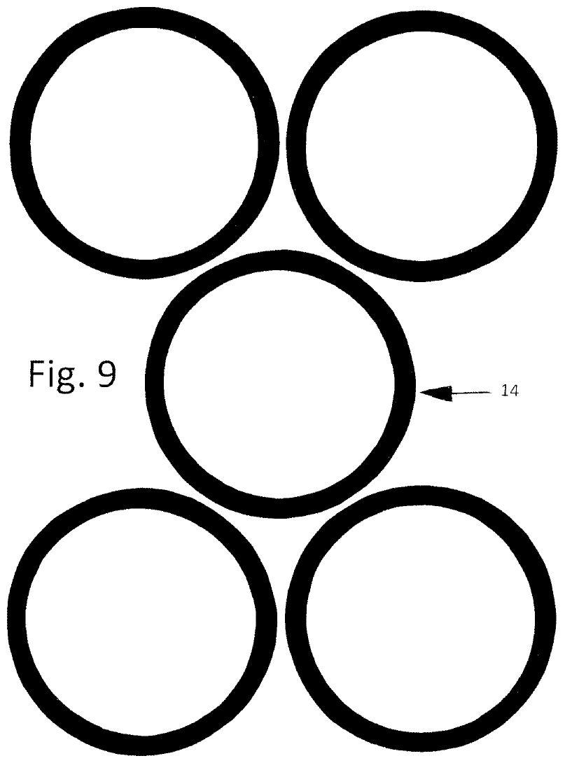

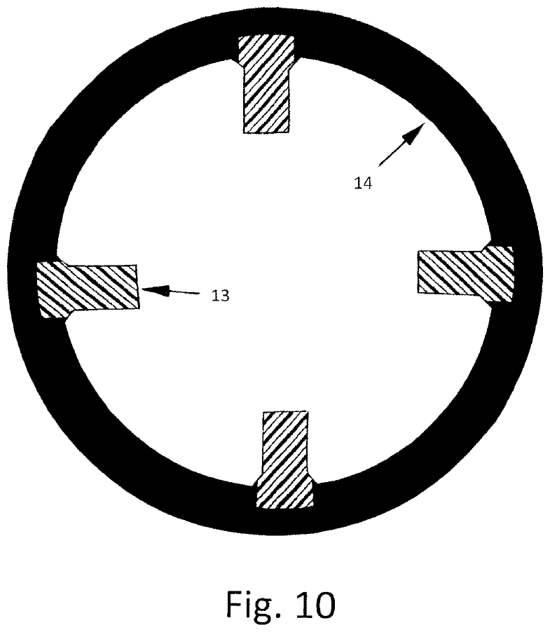

In instances when the coils of the coiled section of pipe 4 are all located below the surrounding ground level, since the preferably circular outer support walls 14 (see FIG. 9), which will preferably be made of recycled plastic that was repurposed to form building blocks (kind of like giant Legos) to hold back the surrounding dirt, will also be able to be used to support the storage tank 1, which will preferably rest on top of the circular outer support walls 14 and have a similar circumference, as well as provide a strong structure to connect the steel support arms 13 to. The main difference in this instance (see FIG. 10), will be that, in addition to being much shorter because they won't have to extend as far if they are not also used to support the weight of the large generators used with larger capacity units using helical horizontal axis turbines, the four rows of steel support arms 13, which will still be supporting each coil, will extend in from the circular outer support walls 14 and preferably be vertically attached, one above the other, to a preferably steel shaft that will also be used to help align and hold the preferably layered building blocks of the circular outer support walls 14 in place and also provide additional structural support.

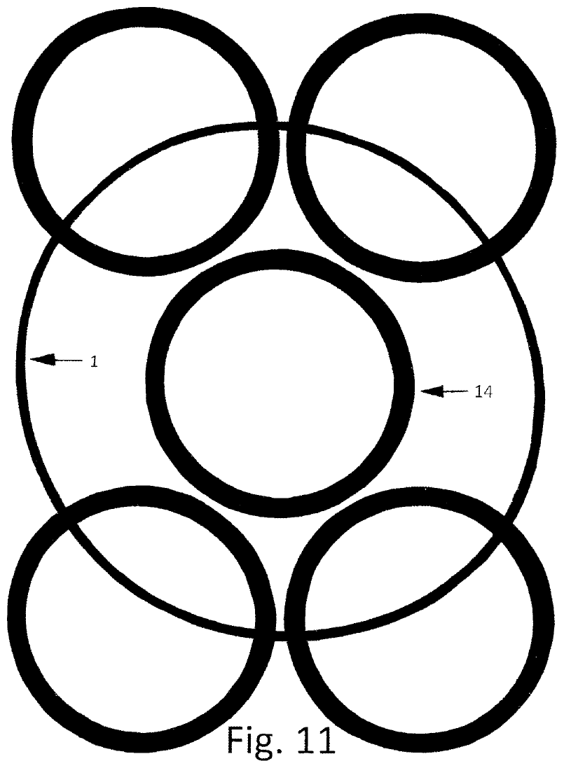

In instances when the storage tank 1 is located on top of a roof or is part of the roof system of a building or other structure, either walls of some sort, or a centrally located steel support column 11, or other steel or steel-like structures, or a combination of any of them or other similar structures may be used to perform the roles of supporting the storage tank 1 and supporting the coils of the coiled section of pipe 4 using steel support arms 13 or other means. The same will also hold true (see FIG. 11) in instances when more than one unit of the invention is sharing and being supplied with water by a single, large overhead storage tank 1 or similar structure.

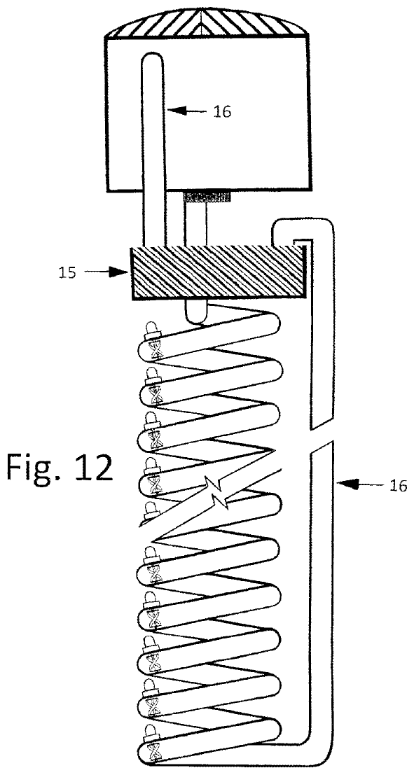

As shown in FIG. 12, a relatively easy way to return the water to the storage tank 1 using an embodiment of the present invention that uses a single ground level pipe 9 and a single return pipe 16, will be to set up a support structure in the form of a platform that will preferably be located below the storage tank 1 in the open space next to the down-pipe 3 and be used to hold a smaller water receptacle 15 for the pressurized water from the return pipe 16 to flow freely up and into due to atmospheric pressure and hydrostatic pressure at a flow rate velocity that preferably exceeds two meters-per-second. Once in the much smaller water receptacle 15 than the storage tank 1 still higher above, a submersible pump (not shown) that is preferably located in the smaller water receptacle 15, will efficiently pump the water vertically back up the remainder of the distance into the storage tank 1 at a rate that at least keeps pace with the amount of pressurized water flowing freely through the main section of pipe 10 and out the top of the return pipe 16 into the smaller water receptacle 15.

During testing by researchers, Gorlov helical vertical axis turbines (U.S. Pat. Nos. 5,451,137 and 5,642,984), even with the flow rate being as low as two meters-per-second (4.474 mph), have been able to extract up to 35% of the kinetic energy of moving water and up to 70% of the kinetic energy of moving water when appropriately curved inserts are placed within a conduit to channel fluid flow to the blades of the turbine, thereby increasing efficiency and power output. In the embodiment of the present invention shown in FIG. 12 and in similar embodiments, the flow rate velocity of the water into the smaller water receptacle 15 will be determined by the difference in height between the open end of the return pipe 15 and the height of the water within the storage tank 1, with the resulting flow rate velocity that atmospheric pressure and hydrostatic pressure can push the steady flow of water up and into the smaller water receptacle 15 increasing with the increased distance between the two heights. So, if the flow rate velocity of the water interacting with each turbine 6 is at least two meters-per-second (which may include increasing the inside diameter of the pipe in the coiled section of pipe 4, or increasing the height of the storage tank 1 and the height of the water within it, or extending the length of the down-pipe 3, or placing the smaller water receptacle 15 down alongside the coiled section of pipe 4), meaning up to 35% of the kinetic energy of the moving water can be extracted, and because the volume of water interacting with each turbine 6 per minute will be the same as that entering the smaller water receptacle 15 per minute, simple math tells us that if there are enough turbines/generators 5 in the coiled section of pipe 4 to produce more electric power when combined per minute than the set amount consumed by the pump per minute, the system will produce surplus electric power.

If the unit shown in FIG. 12 has a single turbine/generator 5 in each coil with each coil having an inside diameter of 10 feet and roughly 30 feet of pipe between each turbine/generator 5. By simply doubling the diameter of the coil from 10 feet to 20 feet an additional turbine/generator 5 can be added to each coil. This will result in the amount of electric power being produced per minute by all the turbines/generators 5 in the coiled section of pipe 4 being doubled, while the length of the pipe between each turbine/generator 5 will still be roughly 30 feet. Similarly, by tripling the diameter of the coil to 30 feet and adding a third turbine/generator 5 per coil, the amount of electricity produced by all the turbines/generators 5 will be tripled. The same pattern also holds true if the coil diameter is increased to 40 or 50 feet.

In addition to larger diameter coils and additional turbines/generators 5 per coil, increasing the inside diameter of the pipe in the coiled section of pipe 4 and the remainder of the main section of pipe 10 as the coil diameter increases will preferably also be done. Also, by having the flow rate velocity of the water entering the smaller water receptacle 15 and interacting with all the turbines/generators 5 determined by the difference in height between the open end of the return pipe 16 and the height of the water within the storage tank 1, having many tens of coils in the coiled section of pipe is clearly possible. And with the ability to add so many turbines/generators 5 to the unit with the volume of water simultaneously passing through all of the turbines 6 simultaneously being pumped up into the storage tank 1, there is no doubt that a unit with a reasonable number of coils can be built that can produce a steady supply of surplus electric power.

In a more preferred embodiment of the invention, albeit still one of the lower capacity embodiments possible, instead of using atmospheric pressure and hydrostatic pressure to move the water up into an intermediary water receptacle to create a water flow and shorten the distance the water needs to be returned to the storage tank 1, the storage tank 1 will no longer be vented and will instead be made airtight and watertight so the upper part of the storage tank 1 can be filled with a compressed gas, preferably compressed air. Because the hydrostatic pressure of the water at the bottom of a unit will be 14.7 psi (pounds-per-square-inch) for every 10 meters or approximately 33 feet of water depth from the surface of the water in the storage tank 1 to the lowest point in the system plus the pressure provided by the air pushing down on the surface of the water in the storage tank 1 (atmospheric air pressure is 14.7 psi at sea level), by filling the upper part of the storage tank 1 with compressed air above 14.7 psi the hydrostatic pressure of the water at the bottom of the unit will be increased commensurate with the increased pressure of the compressed air.

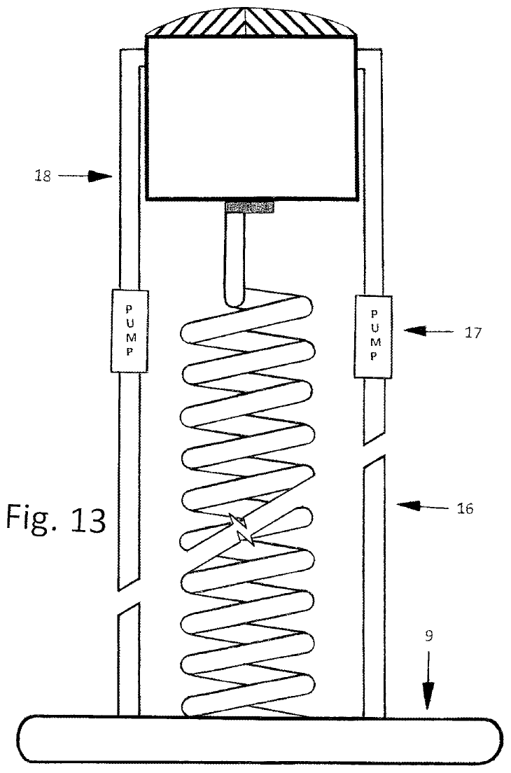

In addition to the potential to increase the hydrostatic pressure of the water at the bottom of the unit by introducing compressed air into the upper part of the storage tank 1 because the hydrostatic pressure, which increases in proportion to the measured depth from the surface because of the increasing weight of the water exerting downward force from above plus any pressure acting on the surface of the water, at least one pump 17 will also be coupled to the top of each return pipe 16 that is incorporated into the system (see FIG. 13). By being directly attached to the top of the return pipe 16, the pump 17 will be able to increase the flow rate of water up through the return pipe 16 instead of it gradually slowing down, even with all the additional pressure provided by the compressed air in the upper part of the storage tank 1, as the operational pressure provided by hydrostatic pressure normally starts to diminish the higher it helps push the water up. This mechanically produced acceleration of the water in the return pipe 16 by the pump 17 will not only increase the overall rate of water flow throughout the system but, by directly attaching the pump 17 to the top of the return pipe 16 and having an upper return pipe 18 extend up from the top of the pump 17 to the storage tank 1, it will do so and still be able to take full advantage of the beneficial effects provided by hydrostatic pressure. This is because the pump 17 is going to produce a considerable amount of additional water flow velocity—especially as part of what is now a closed system that includes the portion from the inlet or suction side of the pumps 17 back down through the return pipes 16 and then back up through the main section of pipe 10 to the surface of the water in the storage tank 1—and be very effective at also increasing the flow rate velocity of the water flowing through the turbines 6 in the coiled section of pipe 4, which will already have the potential to be dramatically increased by the compressed air in the upper part of the storage tank 1 applying constant pressure to the surface of the water in the storage tank 1.

With an ample amount of compressed air trapped in the upper part of the storage tank 1, as well as the pumps 17 that are incorporated into the system coupled to the tops of the return pipes 16, and the partial vacuum or lower pressure zone created by the pumps 17 during their normal operation put to good use to increase and control the flow rate velocity of the water through the watertight and airtight system, another benefit of attaching the pumps 17 to the return pipes 16 will be how they will also increase the overall efficiency and capacity of the power plant. In fact, if done properly, by directly attaching the pumps 17 to the return pipes 16—or even better yet, directly to a larger diameter and volume ground level section of pipe 9 or ground level tank at the bottom of the unit (which will also make it possible to incorporate larger, more powerful and an increased number of pumps 17 into the system)—using the pump or pumps 17 to create a closed system has the potential to dramatically increase the capacity of the power plant well beyond what is possible using only natural forces. That includes placing as many turbines/generators 5 in the coiled section of pipe 4 as is operationally possible beyond the point where the downward flowing water has had a chance to achieve the targeted flow rate velocity controlled by the pump(s) 17, with the turbines/generators 5 possessing the ability to operate normally at much faster flow rate velocities than what gravity, hydrostatic pressure and atmospheric pressure can produce through the coiled section of pipe 4.

One a the most important ways the efficiency of the power plant will be increased by using the pumps 17 to create a closed system has to do with how the system's pumps 17 work and how the pressure of the water entering the pump 17 can be utilized. This is because, after being reduced by a comparatively small amount by the impeller while producing the partial vacuum or lower pressure zone needed for the pump 17 to operate, the pressure of the water entering the pump 17 will be able to be subtracted from the outlet discharge pressure needed to return the water back up and into the storage tank 1 at the desired flow rate. What this means is that whatever the water pressure is before it enters the pump 17 will typically be about 14.7 psi (or atmospheric pressure at sea level and typically about what the water pressure is reduced to create the partial vacuum or lower pressure zone) more than what it is after it enters the pump 17 and that the pump 17 will only need to make up the difference between the water pressure entering the pump 17 and the outlet discharge pressure needed to return the water into the storage tank 1 at the desired flow rate regardless, in this instance because of how the system is configured, of what the pressure of the compressed air in the upper part of the storage tank 1 is, What this also means is that as long as the pressure of the compressed air in the upper part of the storage tank 1 is high enough to drive a constant stream of water through the main section of pipe 10 and up into the pump(s) 17 to produce whatever flow rate velocity is being targeted by the Al-enabled control system, the pump(s) 17 will be able to be positioned at any location along the vertical length of the return pipe 16 with little difference in its efficiency, meaning the amount of electricity used to run the pump 17 will not vary very much.

This will also hold true if the pumps 17 that are incorporated into the system are connected or in communication with the ground level pipe 9 or the pump 17 is connected to the top of a return pipe 16 and the discharge outlet of the pump 1 is connected directly to the storage tank 1. This is because regardless of where the pump 17 is connected to the conduit or conduits that are used to return the water to the storage tank 1, the pump 17 will also only need to make up the difference between the water pressure entering the pump 17 and the outlet discharge pressure needed to return the water into the storage tank 1 at the desired flow rate. And because the hydrostatic pressure, which increases in proportion to the measured depth moving down from the surface because of the increasing weight of the water exerting downward force from above plus any pressure acting on the surface of the water, also decreases in proportion to the measured depth moving up from the bottom of the unit because of the decreasing weight of the water exerting downward force from above but still includes any pressure acting on the surface of the water in the storage tank 1, the loss or gain in hydrostatic pressure as the pump height is raised or lowered is essentially equal to the reduced or increased pressure needed to return the water to the storage tank 1, meaning the amount of electricity needed to run the pump 17 to return the pressurized water to the storage tank 1 will be about the same regardless of where the pump 17 is located.

To better understand how the addition of compressed air into the upper part of the storage tank 1 will affect the ability to return the water from the bottom of the unit back up and into the storage tank 1: If the top one foot of the upper part of the storage tank 1 was filled with 300 psi compressed air and there was 100 feet between the surface of the water in the storage tank 1 and the water at the bottom of the unit, a return pipe that was 800 feet high would be filled with over 770 feet of water. Put another way, if the top one foot of the upper part of the storage tank 1 was filled with 300 psi compressed air, the increased pressure would be like adding more than another 650 feet of height to the typically 20 feet tall storage tank 1 and filling it with water. And, of course, much higher than 300 psi compressed air could easily be used if needed to have the pump or pumps 17 reach and maintain the targeted flow rate velocity of water through all the turbines 6 in the coiled section of pipe 4.

The ability to use the overwhelming pressure provided by the compressed air in the upper part of the storage tank 1 will have several important benefits. First among them, will be the ability to maximize the flow rate velocity of the water flowing down through all the turbines 6 in the coiled section of pipe 4. This is because the overwhelming pressure applied to the surface of the water in the storage tank 1 will not only make it possible to dramatically increase the flow rate velocity of the water flowing down through all the turbines 6 in the coiled section of pipe 4, but it will also make it possible to dramatically increase the kinetic energy possessed by the water and also dramatically increase the amount of energized water interacting with the turbines 6 in the coiled section of pipe 4 per minute. And with the kinetic energy of the water and the amount of energized water interacting with the turbines 6 dramatically increased, the amount of electric power produced by all the turbines/generators 5 in the coiled section of pipe 4 per minute will also be dramatically increased.

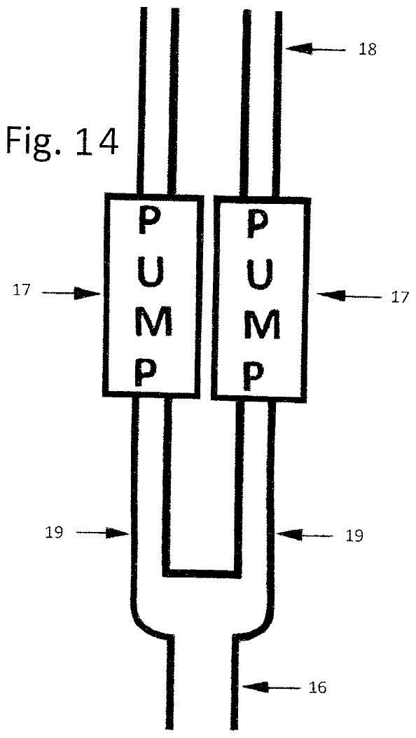

The objective of the invention to have a backup pump 17 for every pump 17 that is included in the system can be accomplished in units with elevated pumps 17 by having a pair of branch pipes—or sister pipes 19—branch off each larger diameter return pipe 16 (see FIG. 14) and extend up the distance needed to avoid any complications from the bend in the pipe. Each sister pipe 19 will then have their own (preferably vertical centrifugal pump, although suction pumps and other types of pumps may also be used) sister pump 17 securely attached to it that will be capable of returning the pressurized water—further enhanced by the capabilities of the pump 17 operating in the watertight and airtight system and benefitting from the partial vacuum or lower pressure zone created by the pump—the remaining distance into the storage tank 1 using an airtight and watertight upper return pipe 18. The Al-enabled control system will ensure that each pump 17 is used and rested an equal amount of time, and predictive analytics will be able to detect any anomalies and irregularities and report them when found. And should one of the pumps 17 need to be repaired or replaced—or just undergo regular maintenance—its sister pump 17 will be able to fill in full time without any interruption in electricity production by the power plant.

Other small-scale capacity embodiments of the present invention (meaning those that preferably produce less than 1 MW of electricity per hour), may operate using one or more pumps 17 to meet their gallons per minute pumping needs by preferably being coupled directly to a larger diameter ground level pipe 9 that is sealed at the end opposite the end coupled to the coiled section of pipe 4. This also means that small-scale capacity units may operate having one or more additional pumps 17 beyond what are needed to meet the unit's gallons per minute pumping needs included among the pumps 17 that are coupled with an airtight and watertight connection to the larger diameter ground level pipe 9, with the additional pumps 17 able to serve as backup pumps and share pumping responsibilities with the other pumps 17 incorporated into the system.

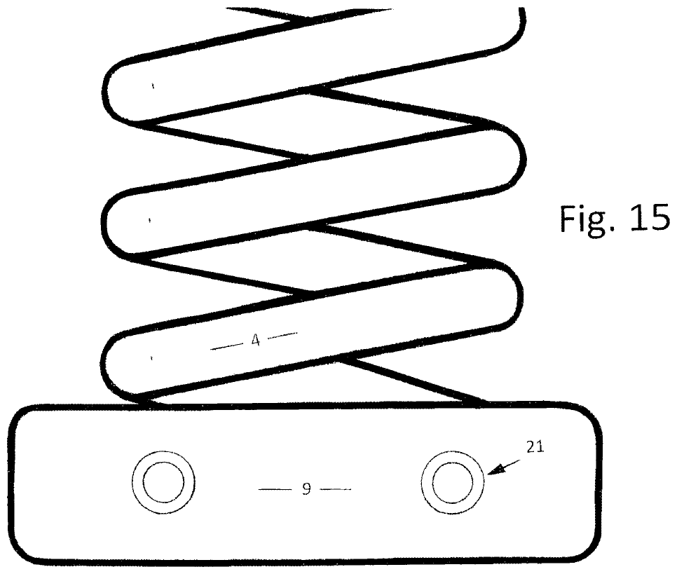

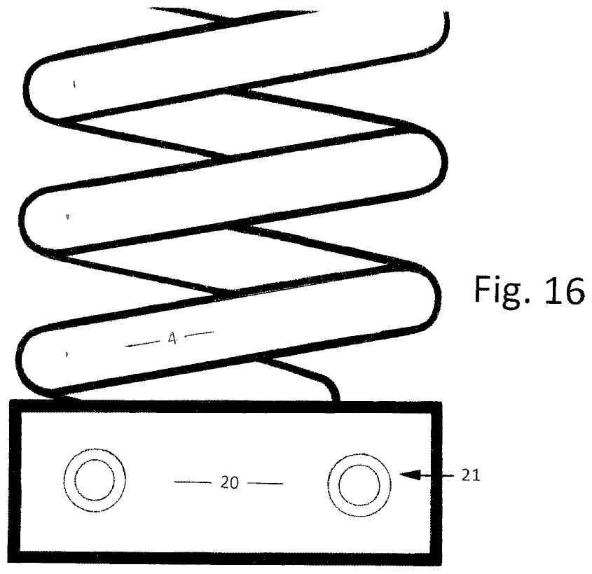

Being able to match the gallons-per-minute (gpm) pumping capacities needed to produce a targeted flow rate velocity of 31.3 mps through the coiled section of pipe 4 will typically take larger, more powerful and an increased number of pumps 17 being incorporated into the system. These large capacity pumps 17 (not shown) will preferably be placed at ground level and preferably be coupled directly to an airtight and watertight, circular or loop-shaped, large volume ground level pipe 9 (see FIG. 15) or a large volume ground level tank 20 (see FIG. 16) using multiple ports 21 built into the circular side of the ground level pipe 9 or using the multiple ports built into the sides of the ground level tank 20, with either ground level water receptacle preferably coupled to the end of the coiled section of pipe 4. Since both the ground level pipe 9 and the ground level tank 20 can be made very large and be airtight and watertight, a large volume ground level pipe 9 could be the better choice in units that utilize a centrally located steel support column 11 to support the storage tank 1, and a large volume ground level tank 20 the better choice in units that utilize circular outer support walls 14 or are combined with buildings or other structures and various structural components to support the storage tank 1.

In large-scale embodiments of the present invention that primarily have the bottom of the storage tank 1 less than 100 feet above the bottom of the ground level pipe 9 or the ground level tank 20, the pressurized water will in many instances be returned straight up to the storage tank 1 using return pipes 16 that are securely coupled to the discharge outlet of multiple centrifugal pumps 17. This will be very efficient and economical to do in large part because of the hydrostatic pressure of the water in the ground level pipe 9 or the ground level tank 20, which will be a direct result of the overall height of the water within the system plus the pressure of the compressed air in the upper part of the storage tank 1, and how, after being reduced by a comparatively small amount by the impeller to produce the partial vacuum or lower pressure zone needed for the pump 17 to operate, the pressure of the water entering each pump 17 will be able to be subtracted from the outlet discharge pressure needed to directly pump the water at the desired flow rate the relatively short distance back up and into the storage tank 1 using a return pipe 16.

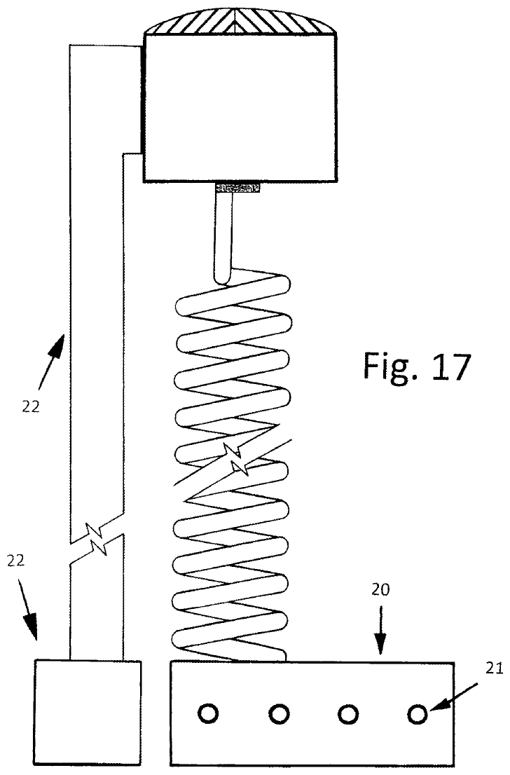

In large-scale embodiments of the present invention that primarily have the bottom of the storage tank 1 more than 100 feet above the bottom of a ground level pipe 9 or a ground level tank 20, the pressurized water will preferably be returned to the storage tank 1 using a return tank 22 (see FIG. 17). FIG. 17 shows a highly efficient embodiment of the FFWN Clean Energy Power Plant using a return tank 22 that will employ eight pumps (not shown), which will connect directly to the trapezoid-shaped ground level tank 20 by four ports 21 on either side and preferably be used to produce large quantities of 24/7, baseload, one-hundred percent clean electricity. Due to how the hydrostatic pressure of the water at the bottom of the ground level tank 20 and the return tank 22 will preferably be the same by having them level with each other, the pumps will be able to move the pressurized water from the ground level tank 20 into the return tank 22—which will be perpendicular to the trapezoid-shaped ground level tank 20 so the eight pumps 17 will have a straight section of pipe running from the pump discharge outlet to the corresponding port 21 (not visible) in the return tank 22—very efficiently, with simple water displacement then automatically returning a steady flow of water of equal volume to the pressurized water entering the return tank 22 all the way back up and into the elevated storage tank 1, regardless of how high it is.

The return tank 22, which will preferably extend from the bottom of the unit up to or near the top of the main storage tank 1, will also preferably be placed near a side of the coiled section of pipe 4 and preferably have a large opening near the top that makes it possible for the level of the water within the storage tank 1 and the return tank 22 to be the same. And because the water will no longer need to be pumped up to the storage tank 1 against the force of gravity, and because the friction from the walls of the pipes or conduits between the pumps and the return tank 22 will be less than the friction from the walls in the longer return pipes 16, and because of how efficiently the pumps 17 will be able to move the pressurized water directly from the ground level tank 20 into the equally pressurized water at the same height in the return tank 22 due to how the pressure of the water entering the pump 17 will be subtracted from the pressure needed at the discharge outlet to move the water into the return tank 22 at the desired flow rate to complete the power producing cycle, less electric power will be used by the pumps 17, which will also mean the power plant will produce more surplus 100% clean electric power per hour.

Naturally, greater energy savings can be realized from the return tank 22 and its use of simple water displacement to return the water back up and into the storage tank 1 by maximizing the number of coils in the coiled section of pipe 4 and the height of the storage tank 1. Maximizing the number of coils and turbines/generators 5 per coil in above ground and below ground embodiments of the present invention will also increase their capacity significantly. And, of course, more coils and their appropriate number of turbines/generators 5 can be added without needing more pumps 17 because the amount of pumping capacity needed to return the even greater hydrostatic pressure water back to its original source—as well as the amount of electricity needed to operate the pumps 17—will largely be uncharged due to how the amount of water being moved per minute to produce the same flow rate velocity through all the turbines 6 in the coiled section of pipe 4 will largely be the same and the hydrostatic pressure of the water in the ground level tank 20 and the return tank 22 at the same depth measured from the surface of the water in the storage tank 1, although greater, will be the same. The only major change will be in how the discharge outlet pressure limits for the large pumps 17 will need to be increased commensurate with the increased hydrostatic pressure in the ground level tank 20 due to the increased height of the water within the system and any increase in the pressure of the compressed air.

Using the pumps 17 and the compressed air in the storage tank 1 to maximize the flow rate velocity of water through all the helical turbines 6 in the coiled section of pipe 4 will be the main reason why this and other large-scale embodiments of the invention will be able to produce so much electricity. Not only will the kinetic energy possessed by the moving water be increased by increasing its flow rate velocity, but by increasing the flow rate velocity the amount of energized water interacting with the turbines/generators 5 per minute will also be increased. For instance, just by increasing the flow rate velocity from the preferred normal operating 28.7 m/s (or roughly 64 mph) to 31.3 m/s (70 mph), the amount of kinetic energy that can be harvested and converted into electrical energy per minute by the turbines/generators 5 will be increased by roughly 33%.

In addition to the partial vacuum or lower pressure zone created at the eye of the impeller of the pumps 17, the main reason why the pumps 17 will be able to control and increase the flow rate velocity of the water moving through the system, starting from when the unit is first turned on and variable frequency drives or variable speed drives preferably have the pumps 17 start to gradually increase the flow rate velocity from zero until the water in the coiled section of pipe 4 reaches the targeted flow rate velocity, will be because there will be a considerable amount of hydrostatic pressure present in the ground level tank 20 due to the height of the water in the system plus the compressed air in the airtight upper part of the storage tank 1 and how it will constantly be pushing down with a considerable amount of pressure on the surface of the water within the storage tank 1. And this combination of compressed air constantly pushing down from above and the hydrostatic pressure at the bottom of the unit (which will certainly be capable of pushing the water in the ground level tank 20 into the pumps by itself), along with some additional assistance from gravity and momentum, will be capable of pushing a steady flow of water down from the storage tank 1, through the down-pipe 3 and coiled section of pipe 4, into the ground level tank 20, and finally into the partial vacuum or lower pressure zone at the eye of the impeller of the centrifugal pumps 17 as the flow rate velocity increases.

Gorlov helical turbines 6 operate under a lift-based concept, so the water will sweep through the turbine 6 as the turbine 6 is harvesting the kinetic energy of the water flowing through it. Still, the potentially high number of rotations-per-minute (rpms) by the helical turbines 6 in large capacity units of the present invention is another matter that will need to be addressed with more robust components and engineering. To begin with, due to the size and weight of the generators 8 and accompanying components, helical horizontal axis turbines 6 will preferably be used with large-scale embodiments of the invention. Having the helical turbines 6 constructed of the most non-corrosive and durable metals or composite materials available—including titanium and stainless steel—will also be preferable. As for the most preferable way to address the potential for very high rpms by the helical turbines 6, which could lead to so-called solidification, will be to use high-wattage and high-torque generators. Moreover, since a generator is a device for converting torque (rotational force) into electric power, and the amount of electric power produced by a generator is directly proportional to the amount of torque supplied to the generator 8 by the turbine 6, by increasing the torque needed to rotate the shaft of the turbine 6 by mechanical means (preferably using gears or a transmission) or electronic means (preferably using torque controllers as is sometimes done with wind turbines in response to high wind speeds)—or both—the speed the turbine 6 rotates will be reduced while continuing to harvest and convert into electrical energy the same amount of kinetic energy because the kinetic energy possessed by the flowing water will be the same.

Using high-wattage, high-torque generators 8 and other means to reduce the speed the turbine 6 rotates will, as testing by researchers has shown, also reduce the resistance or obstruction of water flow by the helical turbines 6. Because helical horizontal axis turbines 6 will preferably have a central shaft that extends out both ends of the turbine 6, two pairs of high strength bearings and bearing housings will also preferably be used by the present invention to provide support to each end of the turbine 6 when the flow rate velocity of the rapidly flowing water is raised to very high velocities by the pumps 17. The bearing housing between the turbine 6 and the generator 8 will preferably be within the connector 7, and the opposing bearing housing will preferably be securely coupled to the opposite side of the pipe in a way that preferably doesn't impede the water flow. Having access to the opposing bearing and bearing housing from outside the pipe will also be preferred. Also, the added cost for higher-wattage, higher-torque generators 8 will almost certainly be offset by the reduced wear and tear on the turbines 6 and generators 8, and result in reduced maintenance costs as well.

For potential embodiments of the present invention that rely primarily on natural forces or those that only use atmospheric pressure from an operational standpoint, proper venting will also be important. That is why when appropriate the storage tank 1 will preferably be vented through the top of the storage tank 1 to the outside atmosphere using multiple vents and why there will preferably be a space for atmospheric air above the surface of the water within the tank 1. In addition to all the benefits provided by atmospheric pressure constantly pushing down on the surface of the water within the storage tank 1, a space for atmospheric air will allow water from the return pipes 16 to flow freely into the top of the tank 1 without encountering any water, only air. By doing so, additional turbines and generators could potentially be placed within the air space above the surface of the water within the tank 1 to harvest some of the kinetic energy of the freely flowing water from the return pipes 16 after it enters the tank 1 and falls downward.

Evaporation of water from the system is another matter that will need to be addressed with adequate remedies in potential embodiments of the present invention that use atmospheric pressure to move water throughout the system. The same holds true for water loss due to leakage in all embodiments of the present invention. Water loss through evaporation through the venting at the top of the tank 1 or through leakage from any part of the system can be mitigated by different ways if doing so makes sense. But the preferred way to replace water lost throughout the system will be to have a supplemental source of water available to each unit that will preferably be accessed by the Al-enabled control system when needed. Municipal water lines and/or storage tanks will certainly be among the potential options for supplemental sources of water that could be pumped up into the storage tank 1 at night or during other times of low energy demand like is done with a typical municipal water tower.

In regard to the present invention being used as part of a water distribution system for homes, businesses, 100% clean infrastructure and industrial purposes, the original embodiment of the present invention, as shown in FIG. 12, was combined with a typical water tower-based municipal water distribution system to take advantage of the water tower to produce baseload, clean, electric power that could be used by the municipality and/or provide it with a revenue source. Other than having the bottom of the storage tank 1 preferably elevated at least 30 meters (or about 100 feet) to produce the necessary amount of hydrostatic pressure for the water distribution system to operate properly, basically all that will need to be added to a unit that relies on atmospheric pressure to keep a steady flow of water through the energy generating part of the system will be a separate water line that can be attached and extend down from the bottom of the storage tank 1 just about anywhere where it can adequately be secured and supported. Once at ground level, the added water line can be used like any other water line from a municipal water tower for water distribution purposes. Then, of course, if a much higher capacity embodiment of the present invention that uses compressed air that was piped into the airtight upper part of the storage tank 1 to increase the flow rate velocity of the water down through the coiled section of pipe 4, a larger storage tank 1 with a separate section for potable drinking water would preferably be how a combined energy generation and water distribution unit would be constructed.

The greater the flow rate velocity of water through the system, the greater the amount of kinetic energy that will be possessed by the water flowing down through the coiled section of pipe 4 and also the greater the amount of highly energized water interacting with the turbines/generators 5 per minute, which, when combined, will dramatically increase the amount of kinetic energy that can be harvested and converted into electrical energy by the turbines/generators 5. With the targeted flow rate of 31.3 mps being used for description purposes as an attainable flow rate velocity to maximize the efficiency of the system, the volume of the water cycling through the system each minute and the number of turbines/generators 5 deployed throughout the system will be the other major determining factors as to how large the capacity of the unit will be.

As previously described, being able to use highly compressed air to constantly push down on the surface of the water in the storage tank 1 with twenty (300 psi) to fifty (800 psi) times more pressure than can be provided by atmospheric air pressure will make it possible to dramatically increase the flow rate velocity of the water down through all the turbines 6 in the coiled section of pipe 4 and help to maximize the electric output of the power plant. For context, 300 psi of compressed air in the top 1 foot of the storage tank 1 would equate to increasing the inside height of the storage tank 1 by more than 650 feet and filling it with water. Even more impressively, 800 psi of compressed air in the top 1 foot of the storage tank would equate to increasing the inside height of the storage tank 1 by more than 1,700 feet and filling it with water. (The empire state building is 1,454 ft. high.) And considering that filling the upper part of the storage tank with 14.8 to 300 psi or 300 to 800 psi (or more) compressed air will not be difficult or expensive to do—not to mention that once the compressed air is trapped in the airtight upper part of the storage tank 1 it isn't going anywhere—doing so for the purpose of assisting in reaching the targeted flow rate velocity of 31.3 m/s, which will be further fostered by applying hydrophobic coatings or other specialty coatings to the interior walls of the pipes to reduce friction, will be invaluable in many units—such as the previous first example unit with a 28″ inside diameter pipe and 85 ft. overall height (20 ft. for the tank 1 and 65 ft. for the pipes and ground level tank 20 underneath)—because of the increased amount of baseload electric power that will be produced per hour with or without the use of the curved inserts.

Obviously, if there is enough available space to raise the overall height of a unit and use larger than 28″ inside diameter pipes in the main section of pipe, in addition to there being much less friction losses for the amount of water rapidly flowing down through the pipes by increasing their inside diameter, there will also be the potential to increase the targeted flow rate velocity of the water, which could also be maximized by using higher psi compressed air in the upper part of the storage tank 1 and by using higher capacity pumps 17. Having centrifugal pumps 17 with pumping capacities of up to 200,000 gpm will also make it relatively easy to use a reasonable amount of pumps 17 as the inside diameter of the pipe and the volume of water per meter of pipe increases. And by using the larger inside diameter pipes and pumps, the total energy generating capacity of the unit will still be able to be at least 33% greater than the nameplate capacity of the unit (or what will preferably be able to be produced 24 hours a day, 7 days a week, 365 days a year). As for how the use of the larger pumps 17, which will preferably be used with larger inside diameter pipe embodiments of the present invention, will have a minor decrease in efficiency as the pumping capacity of the pump 17 increases, the minor decrease in efficiency will be nothing compared to the dramatic increase in surplus electricity that will be produced with the larger capacity embodiments of the invention.

For instance: using the first 28″ inside diameter pipe example unit with 10 coils and 10 turbines/generators 5 in the coiled section of pipe 4, just by increasing the inside diameter of the pipe by eight inches from 28″ to 36″, which will increase the volume of the water in the approximately 100 meter main section of pipe 10 from roughly 10,500 gallons to roughly 17,350 gallons—and still using the targeted flow rate velocity of 31.3 m/s—the capacity of the unit would be increased by about 50% from roughly 9 MW to 13.5 MW of electric power produced each hour—which is without the potential to double the electricity output and capacity of the unit by using the curved inserts.

In instances when it may be necessary, increasing the pressure of the highly compressed air to maximize the flow rate velocity of the water through all the turbines 6 in the coiled section of pipe 4 as the height and/or capacity of a unit increases will also have little or no effect on the ability of the pumps 17 to return the water to the storage tank 1 despite how the increased pressure from the compressed air in the upper part of the storage tank 1 will also increase the hydrostatic pressure in the ground level tank 20 and the return tank 22. This is because the hydrostatic pressure, which increases in proportion to the measured depth from the surface because of the increasing weight of the water exerting downward force from above plus any pressure acting on the surface of the water, will still be the same in both the ground level tank 20 and the return tank 22 at the same depth below the surface of the water in the storage tank 1. As a result, the large centrifugal pumps 17, which will have discharge outlet pressure limits suited for the increased water pressures within the system, will still be able to efficiently move the water entering the ground level tank 20 to the return tank 22, with simple water displacement also still returning an equal volume of water back up into the storage tank 1, regardless of how high it is or how high the water pressure within it is (within reason), to complete the power producing cycle.

In embodiments of the present invention that don't use a return tank 22, another benefit of having highly compressed air essentially trapped in the upper part of the storage tank 1 will be how the resulting increased hydrostatic pressure in the ground level tank 20 will also increase the amount of pressure pushing the water into the partial vacuum or lower pressure zone created by the centrifugal pumps' impellers. With the hydrostatic pressure in the ground level tank 20 increased and providing an equal amount of operational pressure as that provided by the compressed air in the upper part of the storage tank 1 plus the water pressure due to the depth of the water measured from the surface to the midpoint of the impellers, the pumps 17, securely coupled directly to the ground level tank 20, will be assured of having a constant flow of the highly pressurized water into them. Moreover, when return pipes 16 or similar conduits are used to return the highly pressurized water to the storage tank 1, the hydrostatic pressure of the water in the ground level tank 20 (or a large volume ground level section of pipe 9 or other large volume water receptacle), will be increased by roughly the same amount the discharge outlet pressure of the pumps 17 will need to be increased to return the highly pressurized water to the storage tank 1.

As for how additional water can be pumped into the system (while actively being operated or not) when needed due to leakage and/or to bring the pressure of the compressed air in the upper part of storage tank 1 up to the desired psi, it will depend primarily on whether the storage tank 1 is at or near ground level or elevated. In instances when the storage tank 1 is at or near ground level, the water will preferably be pumped into the storage tank 1 by a suitable pump. In instances when the storage tank 1 is elevated, the water will preferably be pumped into the return tank 22 by a suitable pump. In either case, because water is not easily compressed and air is, the water level will rise within the system and the compressed air will be further compressed.

As for how additional compressed air can be piped into the upper part of the storage tank 1, compressed air, preferably stored in carbon fiber storage tanks rated to handle at least 4,500 psi of compressed air, will preferably be used when needed. The stored compressed air will preferably come from an air compressor using surplus electric power from the power plant or from shared infrastructure used by multiple units but can also come from an external electricity source. An external electricity source may also be used to fill the unit with water and compressed air before the unit is put into operation. An external electricity source may also be used to power the pumps when the unit is first turned on or any other time when it is needed. As for instances when the compressed air needs to be reduced or removed, a pressure reduce valve in the upper part of the storage tank 1 will preferably be utilized.

In some embodiments of the present invention, an airtight and watertight elastomer barrier or membrane may be placed in the storage tank 1 between the compressed air (or other compressed gas) and the water (or other liquid) so the compressed air and the liquid do not come in contact. This will not only make it possible to keep oil or other unwanted substances that may accompany the compressed air away from the liquid, but the elastomer barrier or membrane could also make it possible to use an embodiment of the present invention as an electric power source on a spacecraft in space. And because gravity and hydrostatic pressure will not be a factor in space—although the highly compressed air (or other gas) and the partial vacuum or lower pressure zone created by the pump(s) 17 will certainly be able to be used by the pump(s) 17 to maintain a continuous flow of the liquid through the turbines 6 in the coiled section of pipe 4 and simple water displacement will still work to return the liquid back into the storage tank regardless of the shape of the return pipe(s) 16 or return tank 22—the coiled section of pipe 4 could also be oriented horizontally instead of vertically.

Furthermore, because the benefits from gravity in moving the water down through the turbines 6 in the coiled section of pipe 4 and into the pump(s) 17 in Earth-based embodiments of the invention are not nearly as beneficial as what can be achieved by using the compressed air, and because the increase in hydrostatic pressure due to the height of the water in the system in Earth-based embodiments of the invention is not nearly as great as what can be achieved by using the compressed air, by having the orientation of the coiled section of pipe be horizontal instead of vertical while continuing to have the compressed air in the upper part of the storage tank 1, with or without the elastomer barrier or membrane, and continuing to have a ground level tank 20 or other water receptacle for the pump(s) 17 to create a partial vacuum or lower pressure zone within and also use to return the highly pressurized water back to the storage tank 1, potentially even using a shorter return tank 22, will make using a coiled section of pipe 4 that is oriented horizontally in Earth-based embodiments of the present invention not that much different than having the coiled section of pipe oriented vertically from the perspective of how it will function.

In some embodiments of the present invention, the liquid in the storage tank may be pressurized by a hydraulic piston coupled to the storage tank while in others the liquid in the storage tank 1 may be pressurized by an external force applying pressure to an elastomer diaphragm coupled to the storage tank.

By having the bottom of the storage tank 1 elevated to a height of 122 feet (as might be found in a combined energy generation and water distribution unit with a larger diameter storage tank 1 and a separate section for the potable water), the electricity generating capacity of the unit will be increased when compared to the first example unit having a 28″ inside diameter pipe and 10 coils and 10 turbines/generators 5 below the storage tank 1. With at least twice the height (or vertical distance) to work with than the 65 ft. in the first example unit (roughly 47 ft. for the coiled section of pipe 4, 12 ft. for the down-pipe 3, and 6 ft. for the ground level tank 20), by simply doubling the number of coils in the coiled section of pipe 4 from ten to twenty, the number of turbines/generators 5 in the coiled section of pipe 4 can also be doubled from ten to twenty and the capacity of the unit will actually be more than doubled. This is because, even with the total height of the unit increased to 132 ft. (20 ft. for the tank 1 and 112 ft. for the main section of pipe 10 and the ground level tank 20 underneath) the water will still be returned up into the storage tank 1 using roughly the same amount of electricity by preferably using the return tank 22. And by doubling the length of the main section of pipe 10 from roughly 100 meters with a water volume of roughly 10,500 gallons to roughly 200 meters with a water volume of roughly 21,000 gallons, and also the number of turbines/generators 5 in the coiled section of pipe 4 from ten to twenty, the 9.16 MW capacity of the first 28″ diameter pipe example unit without using the curved inserts will be more than doubled to more than 25 MW in a 132 ft. high unit because the amount of electricity used to return the pressurized water up into the storage tank 1 using the return tank 22 will still be roughly the same.

But why stop there? Since the overall height of the coiled section of pipe 4 will be doubled, why not double the diameter and circumference of each coil in the coiled section of pipe 4 as well? By doubling the coil diameter from 10 ft. to 20 ft., the circumference (or overall length) of the circular pipe in each coil will also double from 31.4 ft. to 62.8 ft. And by doubling the circumference of each of the twenty coils in the coiled section of pipe 4 from 31.4 ft. to 62.8 ft., the roughly 200 meters of 28″ inside diameter pipe with a water volume of roughly 21,000 gallons will be doubled from roughly 200 meters to roughly 400 meters (which will extend from the bottom of the storage tank 1 to the top of the ground level tank 20), with the water volume within the main section of pipe 10 becoming roughly 42,000 gallons.

The doubling of the overall length of the main section of pipe 10 from roughly 200 meters to roughly 400 meters, as well as the doubling the circumference of each coil in the coiled section of pipe 4 from 31.4 ft. to 62.8 ft., will also make it possible to add an additional turbine/generator 5 to each of the twenty coils in the coiled section of pipe 4 and still have roughly 30 feet of pipe between each turbine/generator 5. That means that instead of having twenty turbines/generators 5 to produce electricity in the 106 ft. high main section of pipe 10, there will be forty turbines/generators 5 available to produce electricity, and do so, using the same seven 30,000 gpm centrifugal pumps 17, to once again more than double the capacity of the unit. But this time the capacity of the unit will be increased from an already impressive over 25 MW of electric power capable of being produced each hour to more than 57 MW of electric power capable of being produced each hour—which is without the potential to double the electricity output and capacity of the unit by using the curved inserts.

Finally (before turning to embodiments of the present invention that are constructed in bodies of water), other land-based units of the invention with far greater overall length and height main sections of pipe 10 and even greater overall diameter coils and pipes are possible and will surely be constructed above and below ground, or a combination of both. Similarly, even bigger turbines 6 and generators 8 will surely be needed for the wider than 28″ inside diameter pipes in larger units. Likewise, the larger units will almost as surely use larger capacity pumps 17 to produce the high flow rates that will be needed to take full advantage of the larger volumes of water being cycled through larger units of the invention.

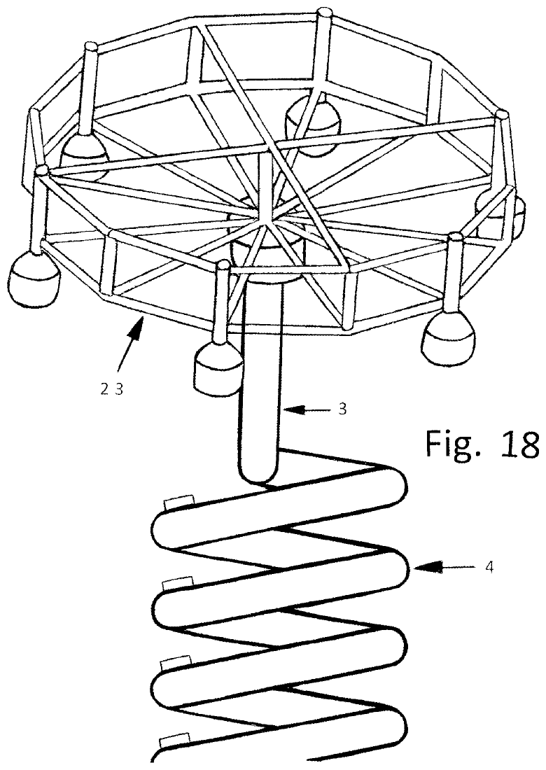

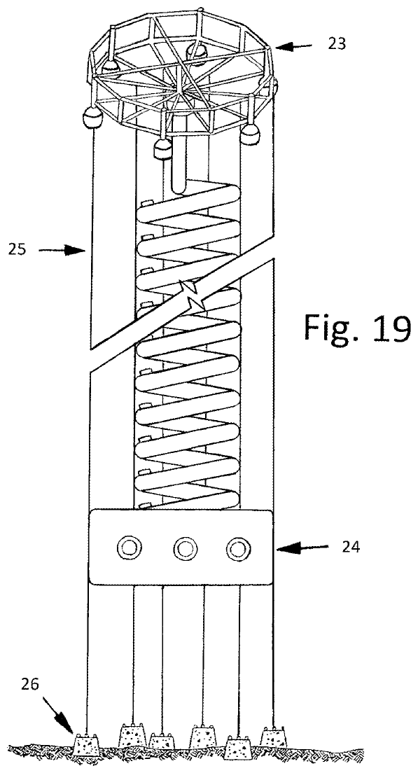

In addition to replacing the storage tank 1 with a floating surface level structure 23 that will be used to keep the unit vertical and will preferably be coupled to the down-pipe 3 (see FIG. 18), one of the biggest differences between land-based embodiments of the present invention and units that are located in bodies of water will be how the pumps 17 are utilized to return the working fluid back to the original source once it reaches the bottom of the unit. Because a unit of the invention that is located in a body of water will preferably have the working fluid—be it from an ocean, sea, lake, pond, river, or other body of water with an adequate depth, including a mine shaft or other man-made or even a water holding enclose of some sort—enter into the system through the down-pipe 3 from the surrounding body of water, the hydrostatic pressure of the liquid within the main section of pipe 10 and the bottom tank 24 (see FIG. 19) will be the same as the hydrostatic pressure of the liquid in the surrounding body of water at an equal distance below the surface.

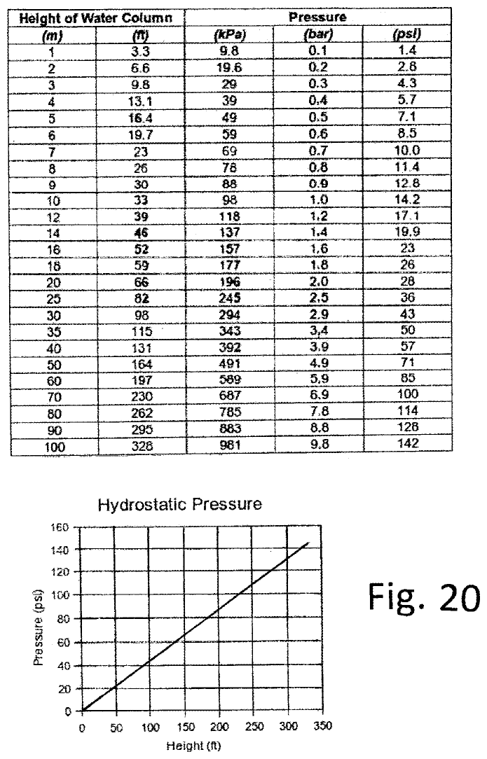

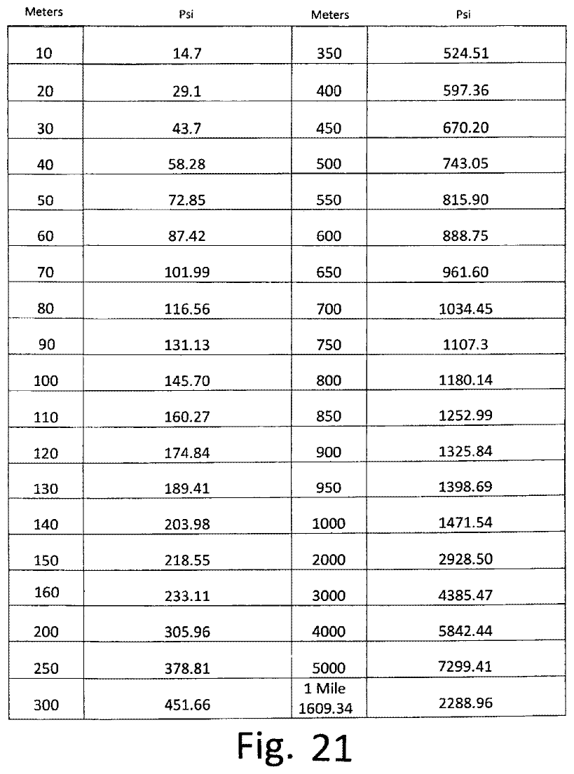

Having the hydrostatic pressure within the main section of pipe 10 (namely the down-pipe 3 and the coiled section of pipe 4) and the bottom tank 24 (although other conduits are certainly possible) the same as the hydrostatic pressure just on the other side in the surrounding body of water at whatever distance below the surface a portion of the main section of pipe 10 or the bottom tank 24 may be, will be extremely important for several reasons: (1) Since the hydrostatic pressure being exerted on both sides of the pipe in the main section of pipe 10 and on both sides of the walls of the bottom tank 24 will be the same—regardless of what preferably strong material or materials the pipes and bottom tank 24 are made of—the rising hydrostatic pressure the deeper the main section of pipe 10 and the bottom tank extends down (see FIG. 20), especially if the bottom of the unit extends down more than 100 meters (see FIG. 21), won't cause the pipe or the walls of the bottom tank 24 to collapse in or blow out. (2) As a result, simple guide wires or cables 25 will preferably be what is used to support and hold the coils of the coiled section of pipe 4 in the proper place between where the guide wires or cables 25 are attached to the floating surface level structure 23 and where they finally end after extending all the way down to preferably large concrete anchors 26 that are used to anchor the unit where they are purposely positioned on the floor of the body of water. Additional buoyancy devices (not shown) may also be added to the guide wires or cables 25 or other parts of the unit, including the bottom tank 24, to support the weight of the unit and help hold it in place. (3) Because the pipes in the main section of pipe 10 and walls of the bottom tank 24 won't collapse in or blow out, as well as how the submersed components of the unit will be properly supported and held in place, the main section of pipe 10 and the bottom tank 24 will be able to extend down quite far. (4) By being able to extend down quite far, many more coils can potentially be added to the coiled section of pipe 4. (5) With many more coils, much more electricity can be produced by the at least one turbine/generator 5 in each of the coils. (6) And because the hydrostatic pressure will be the same on either side no matter how far down the main section of pipe 10 and the bottom tank 24 extends down into the surrounding body of water, it will not be difficult for the pumps 17 to return the water the very short distance back into the surrounding body of water, which is right on the other side of the inside walls of the bottom tank 24, using the ports that either internal or external pumps 17 can connect to in order to pump the pressurized liquid entering into the bottom tank 24 out of the system.

The ability to use the pumps 17 to simply return the pressurized liquid once it reaches the bottom of the unit to the equally pressurized liquid just outside the bottom tank 24 in the surrounding body of water at whatever rate they are simultaneously causing the liquid to flow down through all the turbines in the coiled section of pipe 4 will make the unit incredibly efficient. It will also eliminate the previous need for the pumps 17 to use return pipes 16 or a return tank 22 to return the liquid up into the storage tank 1. This will make it possible for the pumps 17 to be more efficient and consume less electricity if the gallons-per-minute pumping capacities are the same. The ability to just pump the water out of the system at the bottom of the unit will also eliminate the added cost of long return pipes 16 or the return tank 22. This is especially important when you consider that units located in deep water will potentially extend down hundreds of meters. Add in the ability to increase the inside diameter of the pipes and add additional turbines/generators by increasing the diameter of the coils in the coiled section of pipe 4 by a significant amount in very large embodiments of the present invention, and a single unit could potentially be used to power a whole city or seaside community, or even an island of considerable size.

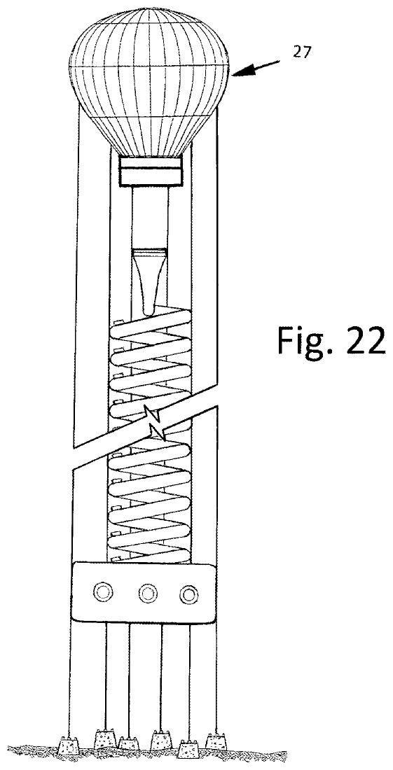

One of the drawbacks of having the working fluid enter the down-pipe 3 at or near the surface of the surrounding body of water if it is a sea, ocean, or other large body of water, will be the potential for electricity production to be interrupted by storms or other undesirable weather conditions. Another option, or potential embodiment of the present invention, that could be constructed to avoid this real possibility will be to locate the main components of the unit underwater. This can be done by removing the floating support structure 23 and lowering the entire unit so a large underwater air bag or balloon 27 can be attached to the down-pipe 3 to keep the unit vertical (see FIG. 22). Because the hydrostatic pressure of the liquid at the lower entry point into the down-pipe 3 will be the same as if it entered at the surface of the surrounding body of water and flowed down to the same depth, the hydrostatic pressure of the liquid in the bottom tank 24 will be the same at the same depth in the surrounding body of water.

Another potential option (or embodiment) will be to use a longer, much more flexible, down-pipe 3 with multiple release valves 2 located at different depths, and/or using additional buoyancy devices that can be deployed as needed, wherever needed.

Finally, after using this document to describe multiple potential embodiments of the present invention that are made possible by innovative concepts and principles that are the basis for the invention and may be beneficial, if not essential, for its successful operation, it is also a purpose of this patent application to disclose that there are a great many more potential embodiments of the present invention that can potentially be constructed using any of the previously described potential embodiments of components, parts, methods and/or systems used in any of the previously described embodiments of the FFWN Clean Energy Power Plant.

Moreover, while the present invention has been described as a land-based power plant or as a power plant located in a body of water, as well as potentially being used as a power plant for use in space, as well as making use of any number of the innovative concepts and principles herein, the present embodiments of the invention—which may already be described herein using multiple embodiments—may be further modified within the spirit and scope of this disclosure. This application is therefore intended to cover any variations, uses, or adaptations of the present invention using its general concepts and principles. Further, this application is intended to cover such departures from present disclosure as come within known or customary practice in the disparate arts to which this invention pertains.

What is claimed is:

1. An electric power plant that produces surplus electric power, comprising:
a storage tank for holding a volume of liquid, wherein pressure is applied to the volume of liquid within the storage tank by atmospheric air pressure, pressure provided by a compressed gas, or pressure produced through mechanical means;
a coiled section of pipe including a plurality of coils;
at least one turbine mounted within the coiled section of pipe, the at least one turbine being coupled to an external electric generator;
wherein the liquid enters into the coiled section of pipe and flows through the coils of the coiled section of pipe, and wherein the at least one turbine in the coiled section of pipe is driven by the liquid to operate the electric generator and thereby produce electric power;
at least one conduit coupled to an end of the coiled section of pipe for returning the liquid to the storage tank; and
at least one pump coupled to the at least one conduit for returning the liquid to the storage tank.

2. The electric power plant of claim 1, wherein the coiled section of pipe includes a plurality of turbines and generators; and
wherein the at least one turbine is a helical vertical axis turbine or a helical horizontal axis turbine, and wherein the at least one generator is adapted to control the rotations-per-minute of the at least one turbine.

3. The electric power plant of claim 1, wherein the at least one conduit coupled to the end of the coiled section of pipe for returning the liquid to the storage tank includes:
at least one ground level section of pipe coupled between the coiled section of pipe and at least one return pipe;
the at least one ground level section of pipe coupled between the coiled section of pipe and the at least one return pipe, the at least one ground level section of pipe including at least one turbine and generator;
at least one substantially straight, vertical section of pipe coupled between the coiled section of pipe and the at least one ground level section of pipe; and
the at least one substantially straight, vertical section of pipe including at least one turbine and generator.

4. The electric power plant of claim 1, wherein the storage tank is supported by at least one support column, and wherein a plurality of support arms are coupled to the at least one support column, and further wherein the support arms are used to provide structural support to the coils in the coiled section of pipe and connected components.

5. The electric power plant of claim 1, wherein the storage tank is at or near ground level and supported by an outer support wall, and wherein a plurality of support arms are coupled to the outer support wall, and further wherein the support arms are used to provide structural support to the coils in the coiled section of pipe and connected components.

6. The electric power plant of claim 1, wherein the at least one pump returning the liquid to the storage tank consumes less electric power than is produced by the at least one turbine and generator during a power producing cycle;
wherein the power producing cycle comprises an amount of liquid the at least one pump will return to the storage tank in a minute; and
wherein the storage tank is filled with liquid using an external pump and power source or the storage tank is filled with liquid with power generated by the power plant.

7. The electric power plant of claim 1, wherein the storage tank is vented, and wherein the liquid in an upper part inside the storage tank is in communication with atmospheric air, and further wherein a release valve and a down-pipe are coupled to the storage tank between the storage tank and a beginning of the coiled section of pipe.

8. The electric power plant of claim 1, wherein the at least one conduit coupled to the end of the coiled section of pipe for returning the liquid to the storage tank includes at least one ground level section of pipe coupled between the coiled section of pipe and at least one return pipe, and wherein at least one smaller liquid receptacle is positioned adjacent or below the storage tank for pressurized liquid to flow freely into after being pushed up and out an open end of the at least one return pipe by hydrostatic pressure and atmospheric air pressure;
wherein gravity, hydrostatic pressure and atmospheric air pressure produce a steady flow of liquid through the coiled section of pipe such that the at least one turbine and generator are driven at a rate determined by a flow rate velocity of the pressurized liquid flowing freely out of the open end of the at least one return pipe and into the at least one smaller water receptacle, and wherein the flow rate velocity of the pressurized liquid flowing freely out of the open end of the at least one return pipe is determined by a vertical distance between the surface of the liquid in the storage tank and the open end of the at least one return pipe, and further wherein at least one pump having a pumping capacity at least equaling the volume of liquid entering the at least one smaller liquid receptacle returns the liquid from the at least one smaller liquid receptacle to the storage tank; and
wherein the at least one turbine and generator in the coiled section of pipe produce more electric power than the at least one pump consumes in returning the liquid to the storage tank during a power producing cycle.

9. The electric power plant of claim 1, wherein the at least one pump controls a rate the liquid moves throughout the system, thereby controlling an amount of electric power produced by the electric power plant;
wherein a flow rate velocity of the liquid controlled by the at least one pump through the at least one turbine in the coiled section of pipe begins at a suction inlet of the at least one pump and, with the assistance of a siphoning effect made possible by a partial vacuum or lower pressure zone created by the at least one pump, extends back through the at least one conduit coupled between the at least one pump and the end of the coiled section of pipe and into the coiled section of pipe; and
wherein the at least one pump uses the partial vacuum or lower pressure zone created by the at least one pump and the pressure applied to the volume of liquid in the storage tank to increase the flow rate velocity of the liquid controlled by the at least one pump through the at least one turbine in the coiled section of pipe, and wherein the increased flow rate velocity of the liquid through the at least one turbine in the coiled section of pipe increases an amount of kinetic energy possessed by the liquid, and further wherein the increased flow rate velocity of the liquid through the at least one turbine in the coiled section of pipe increases an amount of liquid interacting with the at least one turbine in the coiled section of pipe per minute, thereby increasing the amount of electric power produced by the electric power plant per minute.

10. The electric power plant of claim 1, wherein the storage tank is airtight and watertight, and wherein an airtight upper part of the storage tank is filled with compressed gas;
wherein the pressure of the liquid below the compressed gas in the upper part of the storage tank, which includes the liquid in a remainder of the storage tank, a down-pipe, the coiled section of pipe, and the at least one conduit coupled to the end of the coiled section of pipe for returning the liquid to the storage tank, is increased by the compressed gas in the upper part of the storage tank;
wherein a flow rate velocity of the liquid controlled by the at least one pump through the at least one turbine in the coiled section of pipe is increased by the pressure provided by the compressed gas in the upper part of the storage tank, and wherein the increased flow rate velocity of the liquid through the at least one turbine in the coiled section of pipe increases an amount of kinetic energy possessed by the liquid, and further wherein the increased flow rate velocity of the liquid through the at least one turbine in the coiled section of pipe increases an amount of liquid interacting with the at least one turbine in the coiled section of pipe per minute, thereby increasing an amount of electric power produced by the electric power plant per minute; and
wherein the compressed gas is produced using an external power source or by power produced by the electric power plant.

11. The electric power plant of claim 1, wherein the at least one conduit coupled to the end of the coiled section of pipe for returning the liquid to the storage tank includes:
at least one ground level section of pipe coupled to the end of the coiled section of pipe, the at least one ground level section of pipe coupled with an airtight and watertight connection to the at least one pump, wherein a return pipe is coupled to a discharge outlet of the at least one pump with an airtight and watertight connection, and wherein an opposite end of the return pipe is coupled to the storage tank with an airtight and watertight connection;
the at least one ground level section of pipe coupled between the coiled section of pipe and at least one return pipe, an opposite end of the at least one return pipe coupled with an airtight and watertight connection to the at least one pump at any location between a bottom of the power plant and the storage tank, wherein an upper return pipe is coupled to the discharge outlet of the at least one pump with an airtight and watertight connection, and wherein an opposite end of the upper return pipe is coupled to the storage tank with an airtight and watertight connection;
the at least one ground level section of pipe having an inside diameter larger than the inside diameter of the pipe in the coiled section of pipe, the at least one larger inside diameter ground level section of pipe forming an airtight and watertight enclosed loop, wherein the at least one larger inside diameter ground level section of pipe is in communication with the at least one pump, and wherein a discharge outlet of the at least one pump is coupled to the return pipe, the opposite end of the return pipe coupled to the storage tank; and
at least one airtight and watertight ground level tank, the at least one ground level tank coupled to the at least one pump, wherein the discharge outlet of the at least one pump is coupled to the return pipe, the opposite end of the return pipe coupled to the storage tank.

12. The electric power plant of claim 1, further comprising at least one return tank for returning the liquid to the storage tank, the at least one return tank in communication with the at least one pump which is coupled to the at least one conduit coupled to the end of the coiled section of pipe for returning the liquid to the storage tank, and wherein the at least one return tank uses liquid displacement to return an incoming liquid to the storage tank.

13. The electric power plant of claim 1, further comprising a plurality of main sections of pipe coupled to the storage tank to increase the capacity of the power plant, wherein the main section of pipe includes at least the coiled section of pipe, the at least one turbine coupled to the generator and the at least one conduit coupled to the end of the coiled section of pipe and the at least one pump for returning the liquid to the storage tank.

14. The electric power plant of claim 1, wherein the storage tank is airtight and watertight, and wherein the liquid in the storage tank is pressurized by compressed gas, and further wherein there is an airtight and watertight elastomer barrier or membrane between the compressed gas in the storage tank and the liquid on an opposite side of the elastomer barrier or membrane; and
wherein the storage tank is airtight and watertight, and wherein the liquid in the storage tank is pressurized by a mechanical device including a hydraulic piston coupled to the storage tank or the liquid in the storage tank is pressurized by an external force applying pressure to an elastomer diaphragm coupled to the storage tank.

15. The electric power plant of claim 14, wherein the coiled section of pipe is oriented horizontally.

16. An electric power plant that produces surplus electric power, comprising:
a storage tank for holding a volume of liquid, wherein pressure is applied to the volume of liquid within the storage tank by atmospheric air pressure, pressure provided by a compressed gas, or pressure produced through mechanical means;
a substantially straight, vertical section of pipe;
at least one turbine mounted within the substantially straight, vertical section of pipe, the at least one turbine being coupled by a sealed connector to an external electric generator;
wherein the liquid enters into the substantially straight, vertical section of pipe and flows through the substantially straight, vertical section of pipe, and wherein the at least one turbine in the substantially straight, vertical section of pipe is driven by the liquid to operate the electric generator and thereby produce electric power;
at least one conduit coupled to an end of the substantially straight, vertical section of pipe for returning the liquid to the storage tank; and
at least one pump coupled to the at least one conduit for returning the liquid to the storage tank.

17. An electric power plant that produces surplus electric power, comprising:
a body of liquid;
at least one buoyant device for maintaining a substantially vertical orientation;
a coiled section of pipe including a plurality of coils;
at least one turbine mounted within the coiled section of pipe, the at least one turbine being coupled by a sealed connector to an external electric generator;
wherein the liquid enters into the coiled section of pipe and flows down through the coiled section of pipe, and further wherein the at least one turbine in the coiled section of pipe is driven by the liquid to operate the electric generator thereby generating electric power;
a bottom tank or conduit coupled to an end of the coiled section of pipe;
at least one pump for returning the liquid from the bottom tank or conduit to the body of liquid to complete a power producing cycle; and
wherein the at least one buoyant device is secured to a bottom of the body of liquid.

18. The electric power plant of claim 17, wherein the at least one buoyant device comprises a support structure floating on the body of liquid, a down-pipe being coupled to the support structure;
wherein the liquid enters a release valve which is adapted to allow the liquid to flow into the down-pipe at or near the surface of the surrounding body of liquid, and wherein hydrostatic pressure within and outside a main section of pipe is substantially equal at the same measured depth below the surface as the liquid flows downward through submerged parts of the main section of pipe, and further wherein hydrostatic pressure within and outside the bottom tank or conduit is substantially equal at the same measured depth below the surface of the surrounding body of liquid; and
wherein the main section of pipe includes at least the down-pipe and the coiled section of pipe.

19. The electric power plant of claim 17, wherein the at least one pump provides a flow rate velocity down the coiled section of pipe that is at least equal to that achieved by gravity, and wherein the at least one pump coupled to the bottom tank or conduit returns the pressurized liquid in the bottom tank or conduit to the surrounding body of liquid.

20. The electric power plant of claim 17, wherein the at least one buoyant device comprises a balloon or air bag positioned below the surface of the body of liquid, and wherein a down-pipe and the coiled section of pipe are below the surface of the body of liquid, and further wherein the balloon or air bag is anchored to the bottom of the body of liquid.
